(19) United States
(12) Patent Application Publication
(10) Pub. No.: US 2003/0055787 A1
(43) Pub. Date: Mar. 20, 2003

(54) Electronic settlement method

(75) Inventor: Yusaku Fujii, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/091,299

(22) Filed: Mar. 6, 2002

(30) Foreign Application Priority Data
Sep. 20, 2001 (JP) 2001-287525

(51) Int. Cl. G06F 17/60

(52) U.S. Cl. 705/44

(57) ABSTRACT

The invention relates to an electronic settlement method by which the process for transactions is devised in such a manner that receivers can effect a settlement feeling at rest, thereby realizing activation of e-commerce. According to the method, a receiver obtains an electronic information body owned by a supplier and then transmits an electronic information body to a settlement service provider to request the settlement service provider to attach valuable data to the electronic information body, the settlement service provider attaches the valuable data to the electronic information body at the request of the receiver, the electronic information composed of the electronic information body and valuable data is returned to the supplier, and the proprietary right of the valuable data is transferred to a candidate for the receipt of the valuable data by the settlement service provider only when the candidate has been authenticated as a payee oneself.

### BACKGROUND OF THE INVENTION

1. Field of the Invention

The present invention relates to an electronic settlement method for electronically paying the consideration necessary for a commercial transaction by a receiver to a supplier via a settlement service provider upon the transaction between the receiver and the supplier.

In recent years, transactions over the Internet have been actively performed with the spread of the Internet. In keeping with this, cases where transitions accompanied by transfer of money are conducted over the Internet as represented by net auction have increased in not only business to business (B2B), but also consumer to consumer (C2C). However, the figures of companions in transactions are out of sight over the Internet, and so users are followed by the fear of swindle. In settlement by a credit card, there is also a possibility that an erroneous sum may be drawn out by a simple manipulated mistake. The present invention relates to a novel transfer method (electronic settlement method) of money over the Internet for solving these fears.

2. Description of the Related Art

In general, the following systems [a1] to [a3] are used as settlement methods over the Internet. In the following descriptions, the side (shop or the like) of supplying commodities or some services to customers is called a supplier (or supplying side), and the side (the customers) of performing transactions with the supplier and paying the consideration to receive the commodities or some services from the supplier is called a receiver (receiving side). An agent intermediating between the receiver and the supplier upon payment of the consideration necessary for the transactions by the receiver is called a settlement service provider (settlement service side).

[a1] Credit Card System:

In the credit card system, the receiving side informs the supplying side of a credit card number, the expiration of the credit card, etc. to pay the price (consideration) via a credit card company (settlement service provider). The supplying side inputs the credit card number informed from the receiving side into a CAT (Credit Authorization Terminal) to inform the credit card company of the contents of a transaction.

[a2] Prepaid Card (e-money; Electronic Money) System/Electronic Check System:

The receiving side makes a contract with a third party or the settlement service side in advance to pay the proper money to the settlement service side, thereby obtaining a prepaid card number, e-check (electronic check) or the like in advance. The receiving side transmits the prepaid card number, e-check or the like given by the settlement service side to the supplying side upon the purchase of a commodity or service by the receiving side from the supplying side, thereby paying the price (consideration) to the supplying side. The supplying side transfers the prepaid card number, e-check or the like transmitted from the receiving side to the settlement service side to receive the predetermined money from the settlement service side.

[a3] Transfer by Internet Banking (On-line Banking)

The receiving side transfers the money to the designated account of the supplying side, thereby paying the price (consideration) to the supplying side. When this transferring operation is performed on-line using an Internet banking service, the transfer of money comes to be completed over the Internet.

Although the settlement can be made over the Internet by such a system as described above, the figures of companions in transactions are out of sight over the Internet, the settlement over the Internet is always followed by the fear of swindle because of the anonymity inherent in the Internet. In recent years, thus, escrow service capable of securely performing transactions even when the receiving side and the supplying side has no mutual fiduciary relation have been provided, and it has also been conducted to combine the escrow service with the above-described settlement systems.

The escrow service means a service that a reliable third party temporally keeps money upon a transaction between two things unreliable on each other, thereby ensuring a secure transaction. The escrow service is generally performed in accordance with the following steps (b1) to (b6):

(b1) The receiving side orders a commodity, service, license or the like from the supplying side.

(b2) The receiving side deposits money in the escrow service provider.

(b3) The supplying side sends the ordered matter to the receiving side.

(b4) The receiving side confirms the received matter and informs the escrow service provider whether it is the desired matter or not.

(b5) The escrow service provider give the money kept to the supplying side after the provider receives notice to the effect that the received matter is the desired matter from the receiving side.

(b6) When a trouble has arisen between the receiving side and the supplying side, the escrow service provider keeps the money until the trouble is settled.

However, the above-described settlement systems involve such problems as described below.

[c1] Problems Involved in the Credit Card System

[c1-1] Illegality of Supplying-side Employee

When a receiver carries on on-line shipping over WWW (World Wide Web), hands are often intermediated in the course of the settlement of the on-line shopping in many small- or medium-scale enterprises. More specifically, the settlement by a credit card is not automated in many small- or medium-scale enterprises, and an employee inputs a credit card number, the expiration of the credit card, the amount paid, etc., transmitted from a customer (receiving side), are input into a CAT on hand by one's hands to perform the settlement. Namely, the credit card number, the expiration of the credit card, etc. are often exposed to the employee, and so there is a possibility that the credit card number may be stolen or leaked with ease if the employee does a dishonest act.

[c1-2] Mistake in Operation of CAT on Supplying Side

Since the employee operates the CAT in many small- or medium-scale enterprises to perform the settlement as described above, there is a possibility that the employee may make a mistake about the amount paid. If an amount greater than the amount to be actually paid is inputted due to an operational mistake, there is a possibility that more money than requires may be drawn out of the account of the receiving side.

[c1-3] Tapping/theft of Credit Card Number

Since a credit card number flows through over the Internet, the owner of this card is always exposed to a risk of tapping/theft. More specifically, when a receiver makes payment using the credit card, there is a risk that the operation thereof is tapped. If the credit card number or the like inputted over WWW is tapped, there is a possibility that money may be drawn out of the account of the card's owner. In recent years, thus, the tapping/theft has been checked by using a ciphering protocol called SSL (Secure Socket Layer). It is also considered to adopt an exclusive protocol for e-commerce (electronic commerce) called SET (Secure Electronic Transaction). However, SET is not very spread because a new exclusive complex system must be built up on both supplying and settlement service sides for adopting this protocol, and so the cost is increased, and moreover the protocol is hard to be used.

[c2] Problems Involved in the Prepaid Card (e-money) System/e-check System

[c2-1] Tapping/theft of Card Number and e-check Data

Since a card number or e-check data flows through over the Internet (WWW) like the credit card system, the owner of this card is always exposed to a risk of tapping/theft.

[c2-2] Illegality of Supplying-side Employee

Since the card number or e-check is sent to the settlement service side through the supplying side, there is a possibility that the card number or e-check may be stolen and abused if a supplying-side employee does a dishonest act.

[c2-3] Double Use

Since e-money or e-check itself is simple digital data (data string), it can be copied with extreme ease on a terminal of a personal computer or the like. More specifically, the e-check, which is valuable data, can be easily duplicated by a user. Since the duplicate cannot be distinguished from the original thereof, the e-money or e-check before use may be duplicated to doubly use it. Thus, the settlement service side requires to build up a system for preventing double use. Examples of the double use-preventing system include the following system. On the settlement service side, all the management numbers of e-checks cashed in the past are stored in a data base to retrieve, upon cashing of an e-check, whether the management number of this e-check is present in the data base or not, and the e-check is cashed only when the management number is not present in the data base. In such a system, the management number of the e-check cashed must be semipermanentally stored, and so the quantity of data of the management numbers to be stored in the data base is enormous. Accordingly, a memory having an extremely large capacity is required, and so great cost is required for building up the system.

[c2-4] Invasion of Privacy

When an e-check is used in transaction over the Internet, the history of used money of a customer (receiving side) may be left in some cases. More specifically, since the signature of a payer (receiving side) is generally used upon issue of the e-check, the anonymity of money cannot be kept, and so there is a possibility that the account of the money paid on the receiving side may be leaked outside to violate the privacy of the receiving side.

[c3] Problems Involved in the Transfer by Internet Banking (On-line Banking)

[c3-1] Troublesome Operation of Confirming Transfer

When the receiving side performs the settlement for a transaction by transfer making use of on-line banking, the supplying side confirms the notice of transfer from a financial organ and then conducts sending of a commodity, and the like. In the case where the transferring process is used, it takes a comparative time to actually send the commodity because it may take a long time to transfer money (carrying forward to the next day as to transfer on and after 3 p.m., etc. in Japan), and the supplying side may wait information from the bank to the effect that the money has been transferred. The notice of transfer from the bank is generally made by non-electronic information (for example, notice via facsimile), not on-line, and so the supplying side cannot immediately confirm completion of the transfer on the receiving side. Accordingly, operation of confirming the transfer is troublesome for the supplying side, and the waiting time required for the notice of transfer forms a main cause that the operation efficiency of transaction is lowered. Namely, the operation of confirming the transfer cannot be completely automated, and so it takes a comparative time until the commodity is sent.

[c3-2] Swindle on the Supplying Side

The Internet is high in anonymity, and it is thus generally very difficult to confirm the credit of a transactor. Accordingly, swindle is easy to occur, and it is extremely difficult to pursue an offender if the swindle occurs. Accordingly, even if the receiving side finds that the supplying side swindles after the receiving side transfers the predetermined amount of money to be paid to the account of the supplying side, the receiving side cannot take back the money in many cases.

[c3-3] Tapping/theft of Password for Utilizing Internet Banking

Since a password for utilizing Internet banking flows through over the Internet (WWW), the receiving side is always exposed to a risk of tapping/theft like the above-described credit card number, prepaid card number and e-check data.

[c4] Problems Involved in the Use of Escrow Service

As described above, escrow service provides the process for a secure transaction. When an offer of such escrow service is accepted, the receiving side requires to pay the predetermined amount of money to an escrow service provider intermediating between the receiving side and the supplying side. When any of the above-described settlement systems [a1] to [a3] is used in such payment, the same problems as the problems [c1] to [c3] arise after all.

In the conventional settlement systems, users are followed by the fears of tapping, swindle, invasion of privacy, etc. described above. This is considered as a main cause that on-line shopping sites have been not yet actively utilized though they have been increasing in recent years. Accordingly, it is desired from the supplying side to solve such fears as described above in such a manner that receivers can utilize on-line shopping sites or the like feeling at rest, thereby realizing activation of transactions using on-line shopping sites or the like, and in turn increase in sales on the on-line shopping sites or the like.

In the conventional settlement systems (particularly, e-money system and e-check system), great cost is required for building up the double use-preventing system. Thus, it is desired from the settlement service side to develop an electronic settlement method by which a double use-preventing system can be easily and cheaply built up.

### SUMMARY OF THE INVENTION

With foregoing problems in view, the present invention has been made and has as its object the provision of an electronic settlement method by which the process for transactions is devised in such a manner that receivers can effect a settlement feeling at rest, thereby realizing activation of e-commerce using the Internet or the like, and in turn increase in sales, and moreover a double use-preventing system can be easily and cheaply built up.

To attain the above object, according to the present invention, there is provided an electronic settlement method for electronically paying the consideration necessary for a commercial transaction by a receiver to a supplier via a settlement service provider upon the transaction between the receiver and the supplier, the method comprising the steps of obtaining and possessing an electronic information body for transmission of valuable data by the supplier, the electronic information body having a function of holding the valuable data and being recorded therein information for authentication required for authenticating a payee of the valuable data in advance; obtaining the electronic information body, which is owned by the supplier, by the receiver (hereinafter referred to as “obtaining step”); transmitting the electronic information body from the receiver to the settlement service provider to request to attach valuable data having a value corresponding to the consideration necessary for the transaction to the electronic information body (hereinafter referred to as “requesting step”); attaching the valuable data to the electronic information body at the request of the receiver after authenticating the receiver by the settlement service provider (hereinafter referred to as “attaching step”); returning electronic information for transmission of valuable data composed of the electronic information body and the valuable data from the settlement service provider to the supplier (hereinafter referred to as “returning step”); and transferring the proprietary right of the valuable data in the electronic information for transmission of valuable data to a candidate for the receipt of the valuable data by the settlement service provider only when the candidate has been authenticated as a payee oneself of the valuable data on the basis of the information for authentication stored in the electronic information body (hereinafter referred to as “proprietary right transferring step”).

In this method, the function of the electronic information body capable of being used by users other than the proper payee may be limited to a function of attaching or adding valuable data to the electronic information body. At this time, the settlement service provider may prepare an electronic signature for a portion containing the electronic information body and the added valuable data at every time the valuable data is attached or added to the electronic information body in the attaching step to attach it to the electronic information for transmission of valuable data.

In this method, the valuable data attached to the electronic information body in the attaching step may be ciphered by an appointed public key, and a secret key corresponding to the public key may be managed by at least one of the settlement service provider and the payee.

In this method, when a commodity to be transferred from the supplier to the receiver through the transaction is an e-ticket (electronic ticket) or e-pass (electronic pass), the supplier may attach the e-ticket or e-pass as the valuable data to the electronic information body owned by the receiver, at the time the supplier has received the electronic information for transmission of valuable data in the returning step, to send the electronic information body to the receiver.

According to the electronic settlement method of the present invention, the following effects or merits can be achieved.

[1] The electronic information body (e-purse; electronic purse) for transmission of valuable data owned by the supplier is exchanged among the supplier, receiver and settlement service provider, whereby the receiver can electronically pay the consideration necessary for the transaction to the supplier via the settlement service provider. At this time, the receiver can directly control the payment of the price to the supplier, and so the receiver can perform the settlement feeling at rest, and e-commerce using the Internet or the like can be activated to greatly increase sales.

[2] The settlement service provider can issue valuable data at the request of the receiver, whereby the settlement service provider can grasp all valuable data circulating in markets, and so a method of maintaining the security of a system (double use-preventing system) can be simplified to cheaply build up the system.

[3] Since the settlement service provider attaches valuable data to the electronic information body at the request of the receiver, the settlement can be performed without intermediating the system of the supplier at all. In addition, the supplier does not need to inform the settlement service provider of the details of the transaction. Accordingly, it is entirely prevented that the supplier mistakes the amount claimed by operational mistake and that the receiver has one's money stolen by means of unfair practice (swindle or the like) of the supplier. It is also prevented that secret information of the receiver, such as credit card number or password, is leaked to the supplier upon transfer of the money and that the secret information is tapped or stolen over a network such as Internet.

[4] Since the supplier does not need to inform the settlement service provider of the details of the transaction, the information of the receiver is not contained in the valuable data attached to the electronic information body, and the signature of the receiver is not used in electronic signature unlike an e-check, the privacy of the receiver is surely protected.

[5] Since the supplier receives the electronic information returned from the settlement service provider, to which the valuable data has been attached, the amount of money paid can be immediately confirmed, and so the time required to send a commodity can be shortened. The process of notifying the payment can be automated. Besides, the supplier does not need to communicate with a credit company at every transaction with the receiver. Thus, the cost for building up an automation system can be controlled low.

[6] Since the cashing (transfer of proprietary right) of the valuable data attached to the electronic information body can be performed only by a payee oneself registered in said electronic information body in advance, the cashing cannot be performed if another person than the payee oneself intends to cash the valuable data by stealing or duplicating the electronic information containing the valuable data. Accordingly, unfair cashing can be surely prevented.

[7] Issuer information as to the issuer of the electronic information body is stored in this electronic information body confirmably from the outside, whereby everybody can confirm the issuer of the electronic information body (e-purse). It is thereby ensured that the valuable data attached to the electronic information body can be certainly cashed, and so a feeling of ease can be given to users (receiver and supplier).

[8] The valuable data is attached to the electronic information body confirmably from the outside, whereby everybody (receiver, third party or supplier), who has received the electronic information, can confirmed the details (amount of money put in, etc.) of the valuable data upon returning the electronic information body, to which the valuable data has been attached, form the settlement service provider to the supplier.

[9] The electronic information body, to which the valuable data has been attached, is returned from the settlement service provider to the supplier via the receiver, whereby the receiver can finally confirm the amount of money paid before the electronic information is returned to the supplier to judge whether the amount of money put in is correct or not. At this time, since the supplier directly receives the electronic information, to which the valuable data has been attached, from the receiver, the amount of money put in can be immediately confirmed, and so the time required to send a commodity can be shortened to a great extent.

[10] The electronic information body, to which the valuable date has been attached, is returned from the settlement service provider to the supplier via at least one third party other than the receiver registered in advance, whereby the third party can finally confirm the amount of money to be paid before the electronic information is returned to the supplier to judge whether the amount of money put in is correct or not. This is effective in a case where another approver of purchasing is present like the case where the receiver and an actual payer of the consideration are different from each other. Since the payer can check the details of the transaction independent of the receiver, occurrence of unexpected payment attended on, for example, a transaction which is performed under the guise of the receiver can be monitored, and the practice of the payment for such a transaction can be surely prevented.

[11] The destination where electronic information for transmission of the valuable data will be returned or routed is registered in advance on the settlement service provider side, and the electronic information is returned from the settlement service provider to the registered destination or via the registered site on the route, whereby it is difficult to unfairly change the destination or the via-site where the electronic information will be returned or routed. Accordingly, the receiver can put money (add valuable data to) in the electronic information body feeling at rest. When the electronic information is directly returned to the supplier, the electronic information is surely returned to the supplier, and so it is prevented that the electronic information is transferred to a third party to unfairly cash the valuable data and that the transaction is hindered. Thus, the receiver can pay the money to the supplier feeling at rest.

[12] The destination where electronic information for transmission of the valuable data will be returned or routed is stored in advance in the electronic information, and the electronic information is returned from the settlement service provider to the stored destination or via the stored site on the route, whereby a user (receiver, supplier or third party) can confirm the destination or the via-site where the electronic information will be sent by oneself. When the electronic information is directly returned to the supplier, the receiver can have a feeling of ease because the destination to be paid becomes clear. In addition, the supplier can confirm whether the electronic information is certainly returned to one's destination or not.

[13] The information for authentication stored in the electronic information body is used as information for authentication of a payee to be checked with the objective authentication information obtained from the candidate for the receipt of the valuable data upon the authentication of this candidate, whereby a coordinating relation between a payee and the electronic information body can be certainly established, and only the payee oneself can cash the valuable data while retaining the anonymity in the electronic information body. Since the payee authentication information is stored in the electronic information body, there is no need of a system for managing the payee authentication information.

[14] The electronic information body is issued by the settlement service provider, an identifier inherent in the electronic information body is stored as the information for authentication in the electronic information body in advance, and information for authentication of a payee to be checked with the objective authentication information obtained from the candidate for the receipt of the valuable data upon the authentication of this candidate is owned by the settlement service provider in coordination with the identifier, whereby only the payee oneself can cash the valuable data while retaining the anonymity in the electronic information body. In this case in particular, since the payee authentication information is owned on the settlement service provider side, and the identifier is only stored in the electronic information body, unfair cashing by rewriting of the payee authentication information can be surely prevented.

[15] The electronic information body is issued by the settlement service provider, an identifier inherent in the electronic information body is stored as the information for authentication in the electronic information body in advance, and information for authentication of a payee to be checked with the objective authentication information obtained from the candidate for the receipt of the valuable data upon the authentication of this candidate is stored in a portable recording medium in coordination with the identifier, whereby the portable recording medium can be owned and managed by the payee of the electronic information body, and so there is no need to manage the payee authentication information on the settlement service provider side. When biometric information is used as the payee authentication information, the privacy of the payee authentication information can be managed by oneself.

[16] A character string is used as the payee authentication information, whereby the same system as the personal authentication by the password system heretofore widely used can be adopted. The personal authentication system is easy to accepted by users.

[17] The biometric information of the payee oneself is used as the payee authentication information, whereby the personal authentication for the payee can be surely performed, and the security is enhanced. In addition, there is no need for the payee to store the payee authentication information like the password, and there is no need to particularly manage the payee authentication information.

[18] The payee is registered as an owner of the electronic information body or a manager for managing the supplier, and the authentication information of the owner or manager is registered as payee authentication information, whereby a coordinating relation between the owner or manager and the electronic information body can be certainly established, and only the owner or manager oneself can cash the valuable data.

[19] Information transmission among the receiver, supplier and settlement service provider is carried out by means of at least one of wire communication means and radiocommunication means, whereby immediacy is enhanced, and the electronic settlement system can be comfortably utilized.

[20] Information transmission among the receiver, supplier and settlement service provider is carried out by means of exchange of a portable recording medium, whereby the electronic settlement system can be used even in off-line, and there is no need to arrange communication environment.

[21] The settlement service provider performs confirmation of practice on the attachment of the valuable data with a confirmation destination including the receiver and a preregistered third party, whereby unfair transfer of money is ascertained in advance if such a fact is intended to be practiced, and the unfair transfer of money can be prevented, and so security can be more enhanced. At this time, when the confirmation destination is registered in advance on the settlement service provider side, it is difficult for an offender or the like to rewrite the confirmation destination in such a manner that the unfair transfer of money is not detected. When the confirmation destination is stored in the electronic information for transfer of valuable data at any time, the confirmation destination for the transfer of money can be flexibly changed at every use of the electronic information.

[22] Money is kept in advance in the account of the receiver on the settlement service provider side, and the settlement service provider draws the amount of money corresponding to the valuable data attached to the electronic information body out of the account, whereby the settlement service provider can make payment for the electronic information body using the money kept from the receiver in advance, and so trouble of collecting money from the receiver is saved, and moreover there is no risk of failing to recover money corresponding to the amount of money paid from the receiver.

[23] The settlement service provider temporally keeps money drawn out of the account of the receiver and cashes the valuable data by permission of the receiver or returns the money temporally kept to the account of the receiver when the receiver does not permit, whereby the settlement service provider can provide escrow service (third party intermediation) for a transaction between the receiver and the supplier.

[24] When the receiver requests the settlement service provider to annul the valuable data, the settlement service provider returns the money temporally kept to the account of the receiver with supplier's approval as to the revocation of the valuable data, whereby the money kept by the settlement service provider cannot be returned to the account of the receiver unless both receiver and supplier approve, and so the security of the supplier is also maintained.

[25] The receiver makes a contract with the settlement service provider in advance, and the settlement service provider pays the amount of money corresponding to the valuable data for the receiver, and claims the money paid for the receiver to the receiver in the future, whereby the receiver can put the money in the electronic information body without caring about the money left, and so advantage is given to the receiver. Since this method is the same system as the conventional credit card service, the existing credit card service may be used as it is.

[26] The function of the electronic information body capable of being used by users other than the proper payee is limited only to a function of attaching or adding valuable data to the electronic information body, whereby the building up of a system for security maintenance (prevention of duplicating, prevention of double use) is scarcely necessitated in cooperation with the fact that the settlement service provider can manage all valuable data circulating in markets and that only the payee oneself can cash the valuable data. On the contrary, an environment that the electronic information including the valuable data can be duplicated to freely backup it can be provided for users, and so the users can have a feeling of ease to a great extent. Since any duplicate-preventing technique as to the electronic information, to which the valuable data has been attached, becomes unnecessary, the electronic information can be exchanged with extreme ease among the receiver, supplier and settlement service provider, for example, by attaching it to an e-mail.

[27] The settlement service provider prepares an electronic signature for a portion containing the electronic information body and the added valuable data at every time the valuable data is attached or added to the electronic information body to attach it to the electronic information for transmission of valuable data, whereby it is impossible to unfairly take only the valuable data out of the electronic information, and so a third party can unfairly cash the valuable data attached to the electronic information body.

[28] An electronic signature of an issuer of the electronic information body is attached to the electronic information body, or, when the receiver adds additional information to the electronic information body, an electronic signature for the electronic information body and the additional information is prepared to attach it to the electronic information body, whereby it is impossible for a third party to alter the various kinds of information stored in the electronic information body, and so security is enhanced.

[29] The valuable data attached to the electronic information body is ciphered by an appointed public key, and a secret key corresponding to the public key is managed by at least one of the settlement service provider and the payee, whereby a person who can substantiate (cash) the valuable data is limited to the settlement service provider or the payee (owner or manager of the electronic information body) because the secret key is required to correctly decode the valuable data.

[30] The valuable data attached to the electronic information body is ciphered by an appointed public key, and the payee (owner or manager of the electronic information body) possesses a portable recording medium in which a secret key corresponding to the public key has been stored, whereby reading of the valuable data, i.e., cashing can be made only by the owner (payee) of the recording medium in which the secret key has been stored.

[31] When the appointed public key is stored in the electronic information body, the settlement service provider who performs the payment for the electronic information body can immediately get the public key to cipher the valuable data. At this time, when an electronic signature is attached to the electronic information body, security can be ensured because the public key cannot be altered.

[32] The appointed public key is obtained from a fiduciary institution at any time, whereby security can be enhanced because it is difficult to rewrite the public key by any third party.

[33] An electronic signature of the settlement service provider is attached to the valuable data attached to the electronic information body, whereby it can be prevented to rewrite the valuable data by those other than the settlement service provider who is an issuer of the valuable data.

[34] The settlement service provider transfers money to the appointed account upon cashing of the valuable data, whereby the payee (owner or manager of the electronic information body) can conveniently perform cashing on-line using WEB or the like without going to a teller's window.

[35] The settlement service provider delivers money by hand to the payee oneself upon cashing of the valuable data, whereby the payee does not need to open an account with a bank in advance, and so trouble can be saved.

[36] Their inherent identifiers are respectively applied to all valuable data issued by the settlement service provider, and only the identifiers of valuable data circulating in markets are kept by the settlement service provider, whereby all valuable data issued by the settlement service provider among the valuable data circulating in the markets can be grasped. At this time, when an identifier applied to the intended valuable data for cashing is kept by the settlement service provider, the proprietary right of this valuable data is transferred to a candidate for the receipt of the valuable data. Thereby, check of double cashing can be realized with a cheap system, and besides forged valuable data can be found with extreme ease.

[37] Any data (at least one of date, time, name of receiver, address of receiver, telephone number of receiver, e-mail address of receiver, reason for payment of consideration, amount of money of consideration, delivery destination of a commodity dealt with in transaction and electronic information body for transmission of valuable data owned by receiver) is attached to the electronic information body, whereby there is no need for the receiver to separately send the details of order, or the like to the supplier, and so the convenience to the receiver is enhanced, and a coordinating relation between the details of payment and the details of order in the electronic information is made clear, and management by the supplier becomes easy.

[38] The electronic information body owned by the supplier is open to the general public in such a manner that the receiver can get the electronic information body opened to the general public, whereby the receiver can obtain the electronic information body when necessary to make order. Specifically, the supplier does not need to individually contact with each receiver so as to give the receiver the electronic information body.

[39] The settlement service provider issues an electronic checkbook to the receiver, and the receiver attaches the electronic checkbook to the electronic information body and sends it to the settlement service provider so as to pay the consideration necessary for the transaction by the electronic checkbook. At this time, the limited amount payable by the receiver (payable amount information) is always stored in the e-checkbook, and so the receiver can confirm the limited amount at any time. Namely, the receiver can always quickly confirm the money left on hand. Accordingly, the receiver does not need to take the trouble to access the settlement service provider to confirm the money left in the account, or to memorize the money left for oneself, and so the convenience to the receiver is enhanced.

[40] Two or more valuable data are issued by 2 or more different settlement service providers at request of the receiver and attached to one electronic information body. The settlement service provider collects money corresponding to the respective valuable data from the settlement service providers who are issuers of the respective valuable data upon cashing of the two or more valuable data. Thereby, flexibility of the transaction between the supplier and the receiver is increased, and it is convenient for both supplier and receiver. When checks or the like of plural financial organs can be attached to one electronic information body as described above, a manner of using the electronic information body becomes identical with the general e-money, and so convenience (anonymity, environment used by everybody) comparable with the general e-money can be provided for users. Since an issuer of the electronic information body (e-purse) cashes the respective valuable data in cooperation with the respective settlement service providers, the payee does not need to negotiate with a plurality of settlement service providers.

[41] When the valuable data attached to the electronic information body is one having at least one function of electronic money, electronic certificate, electronic ticket and electronic pass, various kinds of variable data can be securely transmitted among the receiver, supplier and settlement service provider. Two or more different valuable data are attached to one electronic information body, whereby the receiver or the owner of the e-purse does not need to separately use a plurality of electronic information bodies, and so the convenience of the receiver or the owner of the e-purse can be more enhanced.

[42] The supplier sends the receiver an electronic ticket (e-ticket) or electronic pass (e-pass) by attaching it as the valuable data to the electronic information body owned by the receiver, whereby a commodity can be delivered to the receiver with certainty and security. At this time, the electronic information body owned by the receiver is attached to the electronic information owned by the supplier when the electronic information owned by the supplier returned from the settlement service provider to the supplier goes via the receiver, whereby the receiver can deliver the electronic information body owned by the receiver to the supplier with extreme ease. When the receiver receives the electronic information body to which the e-ticket or e-pass has been attached, the e-ticket or e-pass can be used by submitting the details of the e-ticket or e-pass. In particular, when the electronic information body to which the e-ticket or e-pass has been attached is received by a portable information terminal, the e-ticket or e-pass can be used with extreme ease by displaying the details of the e-ticket or e-pass on a display part of the portable information terminal to show the display part to a staff or the like.

The above and other objects, features and advantages of the present invention will become apparent from the following description and the appended claims, taken in conjunction with the accompanying drawings.

### BRIEF DESCRIPTION OF THE DRAWINGS

FIG. 1 is a diagram illustrating the constitution of a system, to which an electronic settlement method according to a first embodiment of the present invention is applied, and the procedure of this method;

FIGS. 2 and 3 are diagrams respectively illustrating first and second examples of a method of attaching an electronic signature and adding information to an electronic purse body according to the first embodiment;

FIG. 4 is a diagram illustrating a first example of a method of adding and retaining valuable data in an electronic purse according to the first embodiment;

FIGS. 5 and 6 are diagrams illustrating a second example of a method of adding and retaining valuable data in the electronic purse according to the first embodiment;

FIGS. 7 and 8 are diagrams illustrating a third example of a method of adding and retaining valuable data in the electronic purse according to the first embodiment;

FIG. 9 is a diagram illustrating the constitution of a system, to which an electronic settlement method according to a second embodiment of the present invention is applied, and the procedure of this method; and

FIG. 10 is a diagram illustrating a manner of using an electronic ticket (elctronic pass) according to the second embodiment.

### DESCRIPTION OF THE PREFERRED EMBODIMENTS

The embodiments of the present invention will hereinafter be described with reference to the accompanying drawings.

[1] First Embodiment:

[1-1] Basic Constitution of System to which Electronic Settlement Method According to First Embodiment is Applied:

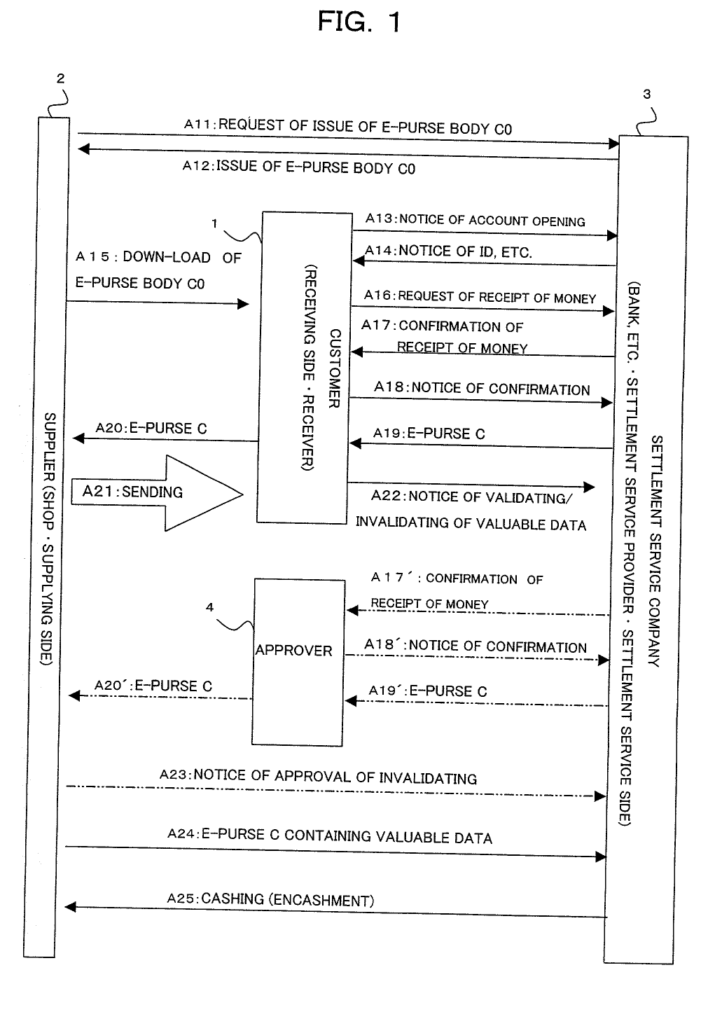

FIG. 1 is a diagram illustrating the constitution of a system, to which an electronic settlement method according to a first embodiment of the present invention is applied, and the process of this method.

With reference to FIG. 1, the basic constitution of the system to which the electronic settlement method according to the first embodiment is applied will be first described.

As illustrated in FIG. 1, the system to which the electronic settlement method according to the first embodiment is applied comprises a shop 2 as a supplying side (supplier) that supplies valuable things such as commodities and services, a customer 1 as a receiving side (receiver) that receives a commodity or service from the supplying side 2 to pay consideration, and a settlement service company 3 as a settlement service side (settlement service provider) that intermediates a transaction between the customer 1 and the shop 2. The electronic settlement method according to this embodiment is a method for electronically paying the consideration necessary for the transaction by the customer 1 to the shop 2 via the settlement service company 3 in such a system as described above. Here, the settlement service company 3 is, for example, a banking organ such as a bank, or a credit card company. Although an approver (third party, approver terminal) 4 is shown in addition to the customer 1 between the shop 2 and the settlement service company 3 in FIG. 1, the approver 4 will be described subsequently.

In this embodiment, the customer 1 is actually a terminal (receiving side terminal) such as a personal computer used by the customer, the shop 2 is a server (supplying side server) equipped on the shop side, the settlement service company 3 is a server (settlement service side server) equipped on the settlement service side. These terminal 1 and servers 2, 3 are connected to one another by data exchange means so as to permit transmitting information.

The data exchange means serve to transmit information among the terminal 1 and servers 2, 3. As the data exchange means, may be used both or one of wire communication and radiocommunication means. Alternatively, a means for exchanging a portable recording medium, in which the information has been stored, among the customer 1, the shop 2 and the settlement service company 3 may also be used.

Examples of the wire communication means include telephone lines, cable television lines, power lines, music transmitting lines, LAN (Local Area Network) and WAN (Wide, Area Network). Examples of the radiocommunication means include portable telephones PHS (Personal Handyphone System) and radio LAN. Examples of the portable recording medium include electronic recording media such as IC (Integrated Circuit) cards and memory cards, magnetic recording media such as magnetic cards and magnetic disks, magneto-optical recording media such as MO (Magneto Optical disk) and DVD (Digital Versatile Disk)/CD (Compact Disk)-R (Recordable)/RW (ReWritable), and prints such as bar codes and letters. When the wire communication or radiocommunication means is used, immediacy is enhanced, and the electronic settlement system can be comfortably utilized. When the portable recording medium is used on the other hand, the electronic settlement system can be used even in off-line, and there is no need to arrange communication environment.

[1-2] Constitution and Function of e-Purse:

A basic feature in the electronic settlement method according to this embodiment resides in that an e-purse (elctronic purse) C is exchanged among the customer 1, the shop 2 and settlement service company 3 by means of the above-described data exchange means, whereby the customer 1 electronically pays the consideration necessary for the transaction to the shop 2.

The constitution and function of the e-purse C will hereinafter be described.

The e-purse (electronic information for transmission of valuable data) C in this embodiment comprises an e-purse body (electronic information body for transmission of valuable data) C0 as a nucleus and is an electronic data for transferring valuable data issued as an electronic data by the settlement service company 3 among the customer 1, the shop 2 and settlement service company 3.

The e-purse body C0 is an e-data that is issued from the settlement service company 3 to the shop (supplier) 2 and owned by the shop 2 and has a function of retaining the valuable data. In this e-purse body C0, is stored authentication information necessary for authenticating a payee (cashing practician, realization practician) of the valuable data. In this embodiment, the payee of the valuable data is the shop (supplier) 2 that is the owner of the e-purse body C0, but may be a manager managing the shop (supplier) 2.

The authentication information stored in the e-purse body C0 is, for example,

(A1) payee authentication information to be checked with the objective authentication information (password, biometric information or the like) obtained from a candidate for the receipt of the valuable data upon the authentication for the candidate for the receipt, or

(A2) an identifier inherent in the e-purse body C0 attached by the settlement service company 3 that is an issuer.

When the authentication information is the identifier inherent in the e-purse body C0, registered payee authentication information comes to be read out based on the identifier to be checked with the objective authentication information obtained from the candidate for the receipt of the valuable data upon the authentication of this candidate. It is thus necessary to manage the e-purse body C0, to which the identifier has been attached, in coordination with the payee authentication information registered in advance. Thus, the coordinating relation between such identifier as described above and the payee authentication information is either stored in a data base in the settlement service company 3 in a table system and managed or recorded in a portable recording medium and managed.

As the portable recording medium, is used, for example, an electronic recording medium such as an IC card or memory card, a magnetic recording medium such as a magnetic card or magnetic disk, a magneto-optical recording medium such as MO or DVD/CD-R/RW, or a print such as a bar code.

As the payee authentication information (objective authentication information), may also be used a password (character string) or biometric information such as fingerprint, voiceprint, iris, retinal vasoganglion, face image, palm print, finger form, palm form, dynamic signature, venus vasoganglion or key stroke.

Issuer information relating to the issuer of the e-purse body C0 is stored in advance in this e-purse body C0 in such a manner that everybody can confirm the details thereof from the outside. More specifically, the customer 1, supplier 2 and approver 4 who have received the e-purse C can make confirmation with reference to the details of the issuer information in the e-purse body C0 on their respective terminals. In this embodiment, since the issuer of the e-purse body C0 is the settlement service company 3, for example, the name of the company (name of financial organ) is stored as the issuer information. It is thereby ensured that the valuable data attached to the e-purse body C0 as described below is certainly cashed, and so a feeling of ease can be given the users (customer 1, supplier 2, or the like). At this time, an electronic signature may be attached to the issuer information so as to prevent the alteration of the issuer information.

As described below, valuable data such as an e-check is attached or added to the e-purse body C0 by the settlement service company 3 at the request from the customer 1. At this time, the valuable data is attached to the e-purse body C0 in such a manner that everybody can confirm the details thereof from the outside. More specifically, the customer 1, supplier 2 and approver 4 (third party) who have received the e-purse C can make confirmation by reference to the details of the valuable data (amount of money of electronic check, etc.) attached to the e-purse body C0 on their respective terminals.

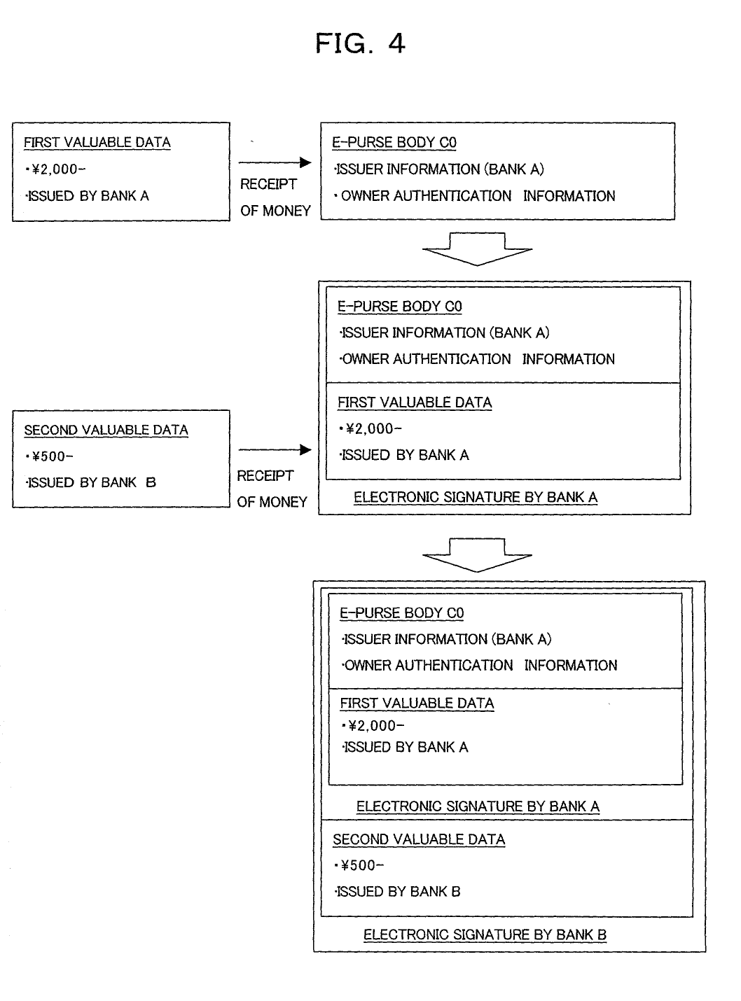

In this embodiment, the function of the e-purse C capable of being used by users other than the proper payee is limited only to a function of attaching or adding valuable data to the e-purse C (e-purse body C0). Thus, the users other than the proper payee can only add the valuable data to the e-purse C, and cannot read (realize/finance) the valuable data attached to the e-purse C. More specifically, the valuable data can be cashed/realized only when the candidate for the receipt of the valuable data has been authenticated as the payee oneself registered in the e-purse body C0 in advance in the settlement service company 3. The manner of adding and retaining the valuable data in the e-purse C (e-purse body C0) will be described subsequently with reference to FIGS. 4 to 8.

[1-3] Process of Electronic Settlement Method According to First Embodiment:

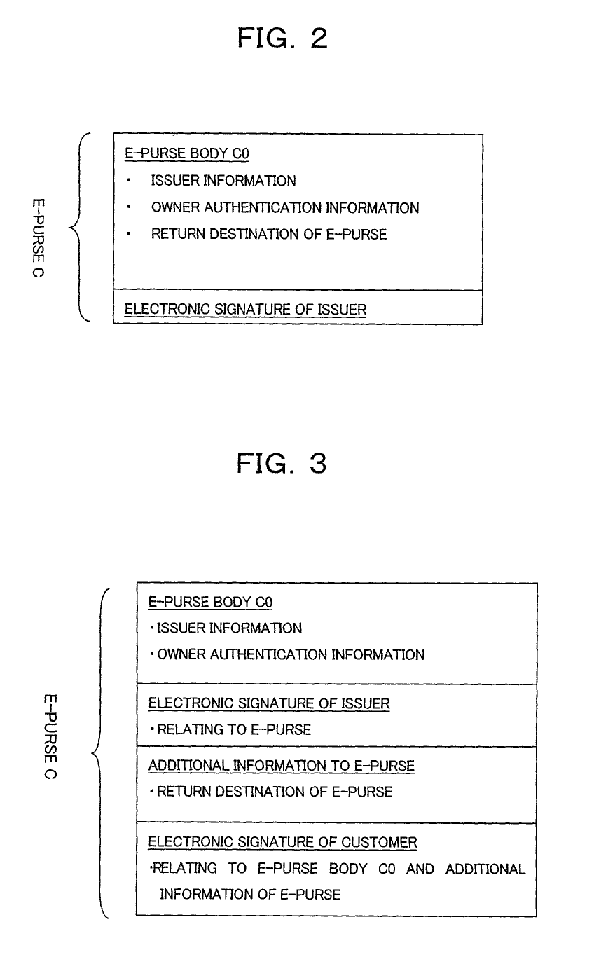

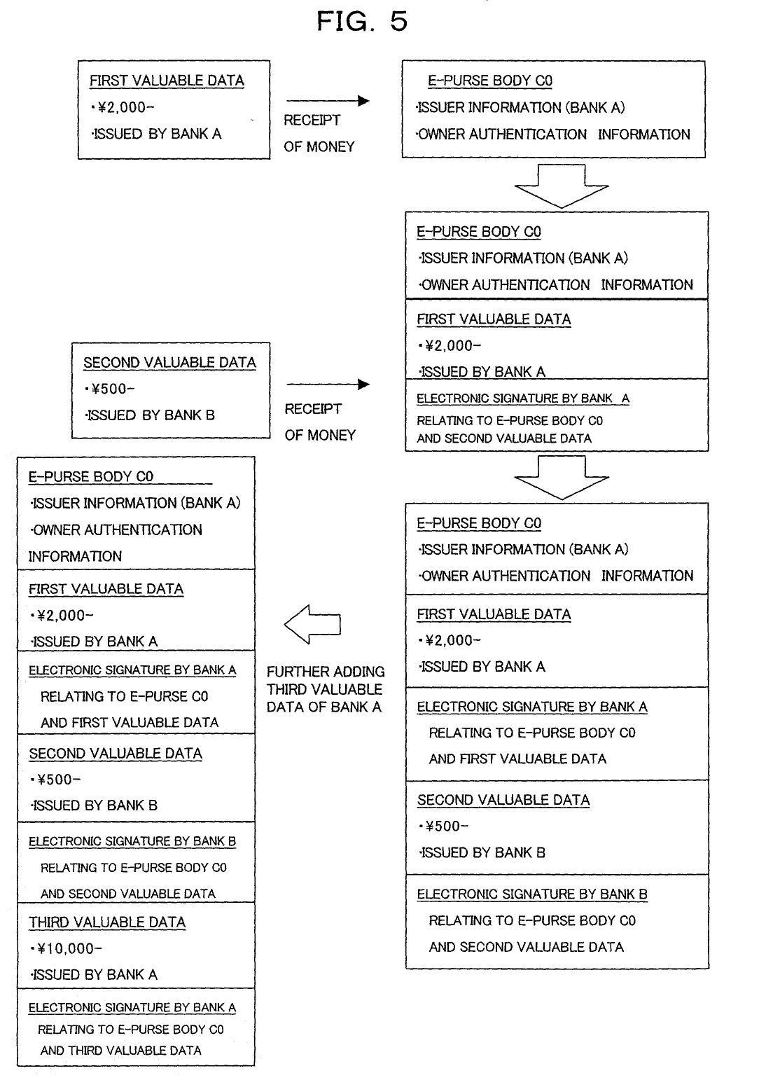

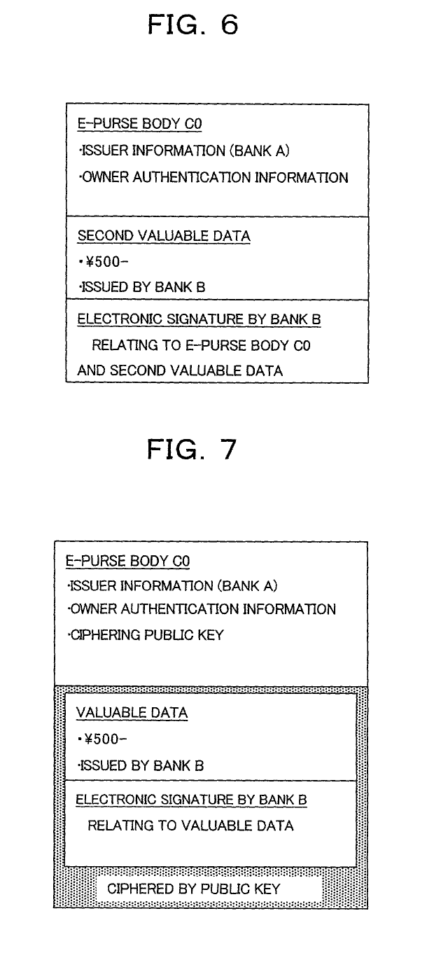

The process of the electronic settlement method according to the first embodiment of the present invention, which is practices with the system and e-purse C constituted in such a manner as described above, will now be described by reference to arrows (Steps, order) A11 to A25 shown in FIG. 1, and FIGS. 2 to 8. FIGS. 2 and 3 are diagrams respectively illustrating first and second examples of manners of attaching an electronic signature and adding information to the e-purse body according to the first embodiment, FIG. 4 is a diagram illustrating an example of a manner of adding and retaining valuable data in the e-purse according to the first embodiment, FIGS. 5 and 6 are diagrams respectively illustrating other examples of a manner of adding and retaining valuable data in the e-purse according to the first embodiment, and FIGS. 7 and 8 are diagrams respectively illustrating further examples of a manner of adding and retaining valuable data in the e-purse according to the first embodiment.

FIG. 1 shows the steps (electronic settlement steps) A11 to A25 of paying the price (consideration) for a commodity (or some service) via the settlement service company (banking organ) 3 when the receiver side (customer) 1 purchases the commodity from the supplying side (shop) 2 by on-line shopping or the like.

[1-3-1] Process of Issuing e-Purse:

The supplying side 2 which is a side that receives the price from the receiving side 1 has the e-purse body C0 (electronic information body for transmission of valuable data) for receiving the price issued from settlement service company 3 prior to a transaction with the receiving side 1 (see arrows A11, A12). The e-purse body C0 is prepared and issued to the supplying side 2 by making a contract with the settlement service side 3.

More specifically, when the supplying side 2 notifies the settlement service side 3 to the effect (request of issue) that an e-purse body C0 will be got issued (see arrow A11), the settlement service company 3 gets personal authentication data (owner authentication information/payee authentication information; actually character string such as password, or biometric information such as fingerprint data) of the supplier 2 who is a payee of valuable data to prepare an e-purse body C0 (see FIGS. 2 to 8) in which this personal authentication data has been stored as authentication information. At this time, issuer information including the information of the settlement service company 3 that is an issuer is also stored in the e-purse body C0 (see FIGS. 2 to 8). The issuer information is, for example, the name of the settlement service company 3 and the date of issue. An electronic signature (digital signature) of the settlement service company (issuer) 3 is preferably attached to the whole of the e-purse body C0 in which the authentication information and issuer information have been stored in such a manner (see FIGS. 2 and 3).

As described above, the authentication information stored in the e-purse body C0 may be personal authentication data (owner authentication information/payee authentication information) itself obtained from the supplier 2 or an inherent identifier attached to the e-purse body C0. When the identifier is used as the authentication information, however, the coordinating relation between the identifier and the personal authentication information is either retained and managed on the settlement service side 3 or managed by the owner (supplying side 2) of the e-purse body C0 in a state recorded in a portable recording medium.

The settlement service company 3 issues and sends the e-purse body C0 thus prepared on the supplying side 2 (see arrow A12). At this time, the supplying side 2 records the e-purse body (actually, simple electronic data of intangible matter) C0 issued from the settlement service company 3 in a portable recording medium to carry it back or get the e-purse body transmitted by an e-mail or the like by means of an wire communication or radiocommunication means. The supplying side 2 gets and possesses the e-purse body C0 in advance in such a manner.

Thereafter, the supplying side 2 opens commodity information to the general public in, for example, a homepage on WWW upon establishing on-line shopping in such a manner that a customer 1 can freely get the e-purse body thereof. Thereby, an environment that the e-purse body C0 can be down-loaded at any time to obtain it is provided for the customer 1 (see arrow A15). The e-purse body C0 may also be opened to general public through magazine and advertisement in addition to the opening to the general public on WWW.

When the e-purse body C0 is opened to the general public, the customer 1 can obtain the e-purse body C0 when necessary to make order of a commodity or the like. Besides, the supplying side 2 does not need to individually contact with each customer 1 so as to give the customer 1 the e-purse body C0.

The e-purse body C0 may also be provided for the customer 1 by storing the e-purse body C0 in a portable recording medium such as an IC card, memory card, magnetic card, magnetic disk, MO, DVD/CD-R/RW or bar code to distribute it to the customer 1.

[1-3-2] Process of Opening Account:

On the other hand, the customer (receiving side) 1 makes a contract with the settlement service company 3 to open an account prior to purchase of a commodity in such a manner that money can be freely deposited in the e-purse body C0, namely, valuable data can be freely attached to the e-purse body C0. At this time, when the customer 1 notifies the settlement service company 3 to the effect that an account will be opened (see arrow A13), the settlement service company 3 establishes the account of the customer 1 and then gets or prepares personal authentication data (customer authentication information) as to the customer 1 and moreover issues customer identification information (customer ID) to retain these customer ID and personal authentication data in coordination with the account.

As the personal authentication data, is used biometric information such as fingerprint data obtained from the customer 1, or character string such as password designated by the customer 1 or prepared by the settlement service company 3. Besides, information (specified terminal information) as to a specified terminal may also be used as the personal authentication data. For example, an IP (Internet Protocol) address or portable telephone number may also be used as the specified terminal information, thereby permitting payment by a specified personal computer or portable telephone.

The settlement service company 3 notifies the customer 1 of both customer ID and personal authentication data (password) when password authentication is performed, or only the customer ID when biometric authentication or authentication by the specified terminal information is performed (see arrow A 14). At this time, the customer 1 may carry the customer ID and the personal authentication data back by memorizing them by oneself or storing them in a portable recording medium, or may get them transmitted from the settlement service company 3 to one's own house by an e-mail or the like. Thereafter, the customer 1 deposits some money in the account opened in advance in such a manner that money can be freely put in the e-purse C.

Although the process through the above-described steps A11 to A14 should have been completed before the electronic settlement service according to this embodiment is used, the customer 1 does not need to conduct the steps A11 to A14 at every time the electronic settlement attended on on-line shopping is performed once this process has been completed. Namely, after completion of the process through steps A11 to A14, the electronic settlement for the payment attended on the on-line shopping is performed in accordance with steps on and after the step A15 as described below.

[1-3-3] Process of Putting Money in e-Purse:

When the customer 1 determines a commodity or service (hereinafter referred to as “commodity” merely) purchased from the shop 2 by on-line shopping, an e-purse C (e-purse body C0) owned by the shop 2 is first got by, for example, down-load over WWW (getting step; see arrow A15). Examples of the commodity include rights for using various services and licenses (e-ticket, e-pass, etc.) such as admission tickets in addition to ordinary goods.

The customer 1 sends the settlement service company 3 the e-purse C thus obtained via e-mail or over WWW for the purpose of paying the price (valuable data having a value corresponding to the consideration for the commodity purchased) for the commodity purchased and moreover requests the settlement service company 3 to pay the price, i.e., attach the valuable data (see arrow A16; requesting step).

At this time, the customer 1 transmits, together with the e-purse C, the amount of the price to be paid in the e-purse C, the customer ID obtained in the steps A13, A14 and the customer authentication information (password or biometric information) to the settlement service company 3 to notify them. When the customer 1 wants to use an escrow service (see arrows A22, A23) which will be described subsequently, the customer 1 informs the settlement service company 3 of that effect upon the transmission of the e-purse C.

On the other hand, when the settlement service company 3 is requested by the customer 1 to pay the price in the e-purse C, the settlement service company 3 first judges whether the customer 1 who is a requester for the payment makes a legal contract with the settlement service company 3 or not (the customer is a contractor of the account opened by the settlement service company 3 or not). When the customer is judged to be a just customer, the settlement service company 3 draws the designated amount of money (the price for the commodity) out of the account of the customer 1 to prepare and issue valuable data, such as an electronic check, having a value corresponding to the amount of money, and the valuable data is attached to the e-purse body C0, thereby putting the money in the e-purse C (attaching step).

When the settlement service company 3 draws the designated amount of money out of the account of the customer 1 to attach the valuable data to the e-purse body C0, it is preferable to confirm whether the drawing of money from the account, i.e., the attaching of the valuable data may be practiced or not with a confirmation destination (see arrows A17, A18). As the confirmation destination, is considered the customer 1 who is a contractor of the account or another third party (for example, an approver 4 shown in FIG. 1) than the customer 1 who has been registered in advance. The confirmation destination may be registered in advance on the side of the settlement service company 3 or stored in advance in the e-purse C (e-purse body C0). The storing of the confirmation destination in the e-purse C (e-purse body C0) is performed, for example, on the terminal of the customer 1. More specifically, the confirmation destination is added as additional information to the e-purse body C0. At this time, an electronic signature (digital signature) for the e-purse body C0 and the confirmation destination information is prepared and attached to the e-purse body C0, whereby alteration of the confirmation destination information is prevented. The confirmation for the confirmation destination is practiced by means of any one of, for example, telephone (including portable telephone and PHS), facsimile, mail, e-mail, remote printing, exclusive communication software, WWW and messenger soft.

More specifically, the settlement service company 3 makes an inquiry about whether the attaching of the valuable data is practiced or nor for the confirmation destination (owner of the account, or the like; customer 1 in FIG. 1) (see arrow A17) and does not perform the preparation and issuing of the valuable data and the payment in the e-purse C unless approval is gained in an answer (see arrow A18) from the confirmation destination to the inquiry. Accordingly, the settlement service company 3 performs the preparation and issuing of the valuable data and the payment in the e-purse C only when the approval as to the payment is gained from the confirmation destination.

The confirmation about whether the attaching of the valuable data is practiced or nor may be performed to a third party other than the customer 1. For example, the settlement service company 3 may perform approval about the payment with the approver 4 who manages the purchase of the commodity for the customer 1 as shown by chain double-dashed line arrows A17′, A18′ in FIG. 1. The approver 4 is, for example, a manager (for example, superior officer to the customer 1 in business) who manages the purchase of the commodity for the customer 1 or an establisher of an account when the customer 1 performs payment with money in the account of another person.

As described above, security can be enhanced by confirming transfer (preparation and attaching of valuable data) of money upon the transfer thereof. For example, if the customer ID and the customer authentication information are stolen when the customer 1 transmits the e-purse C or the like to the settlement service company 3 in the step A16, and an offender thereof has its own e-purse, the customer 1 has a possibility that the money may be stolen by the offender. More specifically, if the offender transmits its own e-purse together with the stolen customer ID and customer authentication information to the settlement service company 3, the settlement service company 3 prepares valuable data corresponding to the amount of money designated by the offender to store it in the e-purse of the offender. In such a case, the fact that the offender intends to unfairly transfer the money can be found before the fact to prevent the customer 1 and the settlement service company 3 from such an unfair action when the function of confirming the drawing of the money from the account is provided as described above as the steps A17, A18 and A17′, A18′.

At this time, the confirming process is performed by using a general means such as a telephone (including portable telephone and PHS), facsimile or e-mail, whereby the confirming process is easy to be accepted by users.

The use of a portable telephone, PHS or the like permits quick confirmation by the confirmation destination such as the owner of the account.

Once the destination of contact upon the confirmation is kept on the side of the settlement service company 3, it is difficult for the offender to rewrite the destination of contact so as not to detect the unfair money transfer. On the other hand, when the destination of contact upon the confirmation is stored in the e-purse C, the destination of confirmation upon the transfer of money may be flexibly changed at every time the e-purse C is used.

When the settlement service company 3 issues valuable data in the attaching step, an inherent identifier capable of being managed by the settlement service company 3 is attached and stored in allotment in the valuable data. The settlement service company 3 keeps the identifiers of the valuable data issued as described above and circulating in markets in a valuable data circulation list to manage them, whereby all the valuable data circulating in the markets at present among the valuable data issued by the settlement service provider 3 are grasped.

When the customer 1 informs the settlement service company 3 to the effect that the escrow service is used in the step A 16, the settlement service company 3 also stores and keeps the account number of the account, from which the price has been paid to prepare the valuable data, together with the inherent identifier in the valuable data.

Similarly, when the customer 1 informs the settlement service company 3 to the effect that the escrow service is used in the step A 16, the settlement service company 3 temporally keeps the money drawn out of the account of the customer 1 upon the preparation of the valuable data so as not to permit a payee to cash the valuable data unless customer's approval is gained. Thus, when the settlement service company 3 puts the inherent identifiers intended for the escrow service in the valuable data circulation list, both a flag (cashing suspending flag) indicating that cashing is not feasible unless customer's approval is gained, and the account number of the account, from which the price has been paid to prepare the valuable data, as to such valuable data are stored at the same time in the valuable data circulation list.

In this embodiment, the valuable data is prepared and issued with the money drawn from the customer's account. However, the customer 1 may make a proper contract with the settlement service company 3 in advance, the settlement service company 3 may pay the amount of money corresponding to the attached valuable data for the customer 1 at request of the customer 1, and the settlement service company 3 may claim the total money paid for the customer 1 to the customer 1 in the future to receive the money of such an amount from the customer 1.

Although the customer 1 makes a contract with the settlement service company 3 before the fact in this embodiment (see steps A13, A14), the customer 1 may directly pay the money in the settlement service company 3 without making such a contract to put valuable data corresponding to the money in the e-purse C.

As described below with reference to FIGS. 4 to 8, the valuable data is attached to the e-purse C (e-purse body C0) by the payment by the settlement service company 3. As described above, users other than the proper payee can only attach and add the valuable data to the e-purse C (e-purse body C0), and cannot take any valuable data out of the e-purse C by itself. The valuable data cannot be cashed unless present with the e-purse body C0, and moreover only the proper payee registered in the e-purse body C0 can cash the valuable data. An electronic signature (digital signature) of the settlement service company 3 is attached to the valuable data attached to the e-purse C issued from the settlement service company 3. When the electronic signature is attached to the valuable data as described above, the details (amount of money, etc.) of the valuable data cannot be altered to prevent the details of the valuable data from being rewritten.

[1-3-4] Returning Process of e-Purse:

The e-purse C, in which the valuable data has been put in the settlement service company 3, is returned to the shop 2 from the settlement service company 3 (see arrows A19, A20 or A19′, A20′; returning step). At this time, the e-purse C is returned to the shop 2 via the customer 1 or at least one third party (for example, approver 4) other than the customer 1 registered in advance.

At this time, the settlement service company 3 returns the e-purse C to a predetermined address as a return destination/routing destination (hereinafter referred to as “return destination”) registered in advance via an e-mail (see FIG. 19 or 19′; returning step). The return destination of the e-purse C may be registered in advance on the side of the settlement service company 3, or stored in advance in the e-purse (e-purse body C0) itself as shown in FIG. 2 or 3.

When the return destination of the e-purse C is registered in advance on the side of the settlement service company 3, it is difficult to unfairly change the return destination of the e-purse C, and the customer 1 can put money in the e-purse C feeling at rest. When the e-purse C is directly returned to the shop 2 without going through the customer 1 or approver 4 as described below, the e-purse C is surely returned to the shop 2, and so it is prevented that the e-purse C is transferred to a third party to unfairly cash the valuable data and that the transaction is hindered. Thus, the customer 1 can pay the money to the shop 2 feeling at rest.

The return destination of the e-purse C is stored in advance in the e-purse (e-purse body C0) itself, a user [customer 1, shop 2, third party (approver 4)] can confirm the destination where the e-purse will be sent by oneself. When the e-purse C is directly returned to the shop 2 without going through the customer 1 or approver 4 as described below, the customer 1 can have a feeling of ease because the destination to be paid becomes clear. In addition, the shop 2 can confirm that the e-purse C is certainly returned to one's destination.

When the customer 1 receives the e-purse C from the settlement service company 3 via e-mail or the like as indicated by arrow A19 in FIG. 1, the details of the valuable data in the e-purse C are confirmed to confirm the amount of money put in the e-purse C. Thereafter, the customer 1 adds and attaches commodity information such as the number of a commodity purchased, delivery destination information and the like as additional information to the e-purse body C0, an electronic signature of the customer 1 is attached to the whole of the e-purse C (see FIG. 3), and the e-purse C is then transmitted to the shop 2 via e-mail or over WWW (see arrow A20). When the escrow service is used in this settlement, the customer 1 stores a copy of the e-purse C received.

In the conventional payment system by a credit card, there a possibility that an erroneous amount of money may be claimed has been left because the customer 1 cannot confirm the final amount of money paid. The reason for it is that the settlement by the credit card is not completely automated in many small- or medium-scale enterprises, and an employee inputs the details of order from the customer 1 into a CAT by one's hands. Namely, a possibility that the employee may make a mistake at the time the amount of money is inputted into the CAT has been left.

On the other hand, according to the present invention, the e-purse C is returned to the shop 2 via the customer 1 as described above, whereby the customer 1 can finally confirm the details of the valuable data attached or added to the e-purse C to judge whether the amount of money paid is correct or not and moreover can control the payment to the shop 2. At this time, since the e-purse C, in which the money has been put, is returned to the address of the customer 1 registered from the settlement service company 3, the password for receipt of money cannot be unfairly utilized to steal money even if the password is tapped in the requesting step or the like.

When the e-purse C is returned to the shop 2 from the settlement service company 3 via the approver 4 as shown by chain double-dashed line arrows A19′, A20′ in FIG. 1, the approver 4 confirms the details of the valuable data in the e-purse C to confirm the amount of money put in the e-purse when the approver 4 receives the e-purse C (see arrow A19′). At this time, when information as to the commodity purchased is contained, the approver 4 judges whether the current purchase of the commodity by the customer 1/payment is approved or not in view of such information and the amount of money for the valuable data by reference to the information. When not approved, the approver 4 informs the customer 1 and the settlement service company 3 of that effect to stop the current electronic settlement. When approved, the approver 4 transmits the e-purse C to the shop 2 via e-mail, WWW or the like (see arrow A20′).

As described above, the e-purse C is returned to the shop 2 via the approver 4, whereby the approver 4 (third party) can finally confirms the details of the valuable data attached or added to the e-purse C to judge whether the amount of the money paid is correct or not before the e-purse C is returned to the shop 2. This is effective in a case where another approver (for example, superior officer to the customer 1 in business) 4 of purchasing is present like the case where the customer 1 and an actual payer of the consideration are different from each other. Since the payer can check the details of the transaction independent of the customer 1, occurrence of unexpected payment attended on, for example, a transaction which is performed under the guise of the customer 1 can be monitored, and the practice of the payment for such a transaction can be surely prevented.

The e-purse C may be transmitted from the settlement service company 3 to a plurality of addresses. More specifically, the e-purse C may be transmitted to the shop 2 via a plurality of addresses. Persons who have received the e-purse C can thereby confirmed the flow of the valuable data. At this time, only the proper payee registered in the e-purse body C0 and authenticated by the payee authentication information can cash the valuable data attached to the e-purse C even when the e-purse C is transmitted to plural persons. Accordingly, the third party only can confirm the details of the valuable data, and the like, and cannot do a dishonest act such as freely cashing the valuable data even if the e-purse C has been received.

In the embodiment shown in FIG. 1, the settlement service company 3 returns the e-purse C to the shop 2 via the customer 1 or the approver 4. However, the e-purse C may also be directly returned to the shop 2 without going through the customer 1 or the approver 4. In this case, there is no need for the customer 1 to transmit the e-purse received from the settlement service company 3 to the shop 2, and so the purchasing process for the customer 1 is simplified. Since the money to be paid designated by the customer 1 is paid to the shop 2 unless the settlement service company 3 does a dishonest act, the customer 1 can perform a transaction feeling at rest.

[1-3-5] Manner of Attaching Electronic Signature/Manner of Adding Information to e-Purse:

When the return destination of the e-purse C is stored in the e-purse C (e-purse body C0), the return destination information may be stored in the e-purse body C0 as illustrated in FIG. 2 or attached or added as additional information to the e-purse body C0 as illustrated in FIG. 3. Here, manners of attaching an electronic signature (digital signature) and adding information to the e-purse body C0 will also be described collectively in connection with the storing of the return destination in the e-purse C (e-purse body C0).

In the first example shown in FIG. 2, the return destination of the e-purse C is stored in advance in such a manner that everybody can confirm it from the outside. When the return destination of the e-purse C is determined at the time the settlement service company 3 issues the e-purse body C0, the return destination information can be stored together with the issuer information and owner authentication information in the e-purse body C0 upon issuing of the e-purse body C0 by the settlement service company 3, for example, when the e-purse C is directly returned from the settlement service company 3 to the shop 2. As shown in FIG. 2, an electronic signature of the issuer (settlement service company 3) is attached to the e-purse body C0 to which these information have been attached. Such attachment of the electronic signature to the e-purse body C0 can prevent a wrong third party or the like from altering various kinds of information stored in the e-purse body C0, and so security can be enhanced.

In the second example shown in FIG. 3, a user such as the customer 1 attaches and adds various kinds of information such as the return destination information as additional information to the e-purse body C0 after the e-purse body C0, to which the electronic signature of the issuer has been attached, is issued. At this time, additional information is attached to the e-purse body C0 in such a manner that everybody can confirm the details thereof from the outside. The return destination of the e-purse C is attached or added by the customer 1 to, for example, the e-purse body C0 to be sent to the settlement service company 3 upon request of receipt of money. When the customer 1 or the approver 4 sends the shop 2 the e-purse C from the settlement service company 3, various kinds of information (commodity information, delivery destination information, etc.) are attached or added as additional information to the e-purse body C0.

When the customer 1 attaches the return destination (customer 1 or approver 4) as additional information to the e-purse body C0, an electronic signature of a receiver of money (here, customer 1) is attached to both e-purse body C0 and additional information. When the customer 1 or the approver 4 attaches notice information to the shop 2 as additional information to the e-purse body C0, an electronic signature of the customer 1 or the approver 4 is attached to both e-purse body C0 and additional information, whereby the additional information attached to the e-purse body C0 is prevented from being altered by a wrong third party or the like, and so security can be enhanced. In addition, it is impossible to separate the additional information from the e-purse body C0.

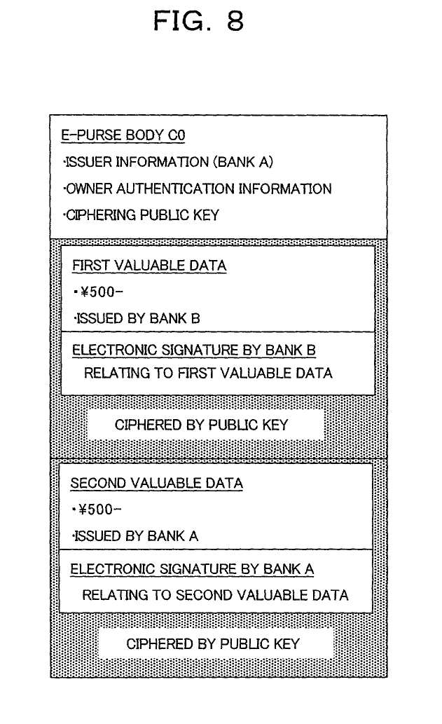

Any data (additional information) can be attached and retained to and in the e-purse body C0 by a user (customer 1, shop 2, settlement service company 3 or approver 4). As the data, may be attached date, time, name of customer 1, address of customer 1, telephone number of customer 1, e-mail address of customer 1, reason for payment of consideration, amount of money of consideration (amount or money receiver or paid), delivery destination of commodity dealt with in transaction, e-purse body (electronic information body for transmission of valuable data; see reference character K0 in FIG. 9) owned by customer 1, and or the like. An example where the e-purse body K0 owned by the customer 1 is attached to the e-purse body C0 will be described in the second embodiment.

A region, in which the customer 1 or the approver 4 can store items of which informs the shop 2, is provided in the e-purse C to attach any data to the electronic information body, whereby there is no need for the customer 1 to separately send the details of order, or the like to the shop 2, and so the convenience to users (customer 1 and shop 2) is enhanced, and a coordinating relation between the details of the receipt of money and the details of the order is made clear, and management in the shop 2 becomes easy.

[1-3-6] Delivery Process of Commodity:

When the supplier (shop) 2 receives the e-purse C from the customer 1 (approver 4 or settlement service company 3) (see arrows A20, A20′), the details (amount of money received) of the valuable data and purchase commodity information attached to the e-purse body C0 are confirmed. At this time, the supplier 2 confirms that the data in the e-purse C are not altered by means of the electronic signatures (three of preparator of e-purse C, preparator of valuable data and preparator of commodity information). When the amount of money received is correct, and the data are not altered, the supplier 2 sends the delivery destination (here, customer 1) the ordered commodity by reference to the delivery destination information attached to the e-purse C (see arrow A 21).

In this embodiment, since the supplier 2 directly receives the e-purse C, to which the valuable data has been attached, from the customer 1, there is no need for the supplier 2 to wait the notice of payment from a bank or the like the payment by the conventional Internet banking, and everybody can confirm the details of the valuable data and various kinds of information attached to the e-purse C from the outside, and so the supplier 2 can immediately confirm the amount of money received. Accordingly, the time required for the sending of the commodity can be greatly shortened.

The customer 1 receives the commodity and then confirms the details thereof. When the customer 1 uses the escrow service, the customer 1 confirms the commodity and then transmits a copy of the e-purse C kept in advance and the effect that the cashing of the valuable data attached to the e-purse C is permitted (notice of validity/invalidity of valuable data) to the settlement service company 3 (see arrow A22). The settlement service company 3 checks the identifier of the valuable data in the e-purse C and resets the cashing suspending flag stored together with the identifier inherent in the valuable data in the valuable data circulation list to make a state that the valuable data attached to the e-purse C can be cashed. The details of the escrow service will be described subsequently.

[1-3-7] Cashing Process of Valuable Data:

Lastly, the supplier 2 carries the e-purse C containing the valuable data in the settlement service company 3 (see arrow A24) to get the valuable data in the e-purse C cashed in this settlement service company 3 (see arrow A25).

When the e-purse C is carried in, the settlement service company 3 judges whether a candidate for cashing (candidate for receipt) of the valuable data is a payee oneself (proper payee) or not based on the authentication information stored in the e-purse body C0.

At this time, the settlement service company 3 gains the objective authentication information (password, biometric information or the like) from the candidate for cashing, and when authentication is payee authentication information (owner authentication information) itself, the payee authentication information is compared with the objective authentication information thus obtained to perform authentication for the payee. When the identifier inherent in the e-purse body C0 is used as authentication information, the settlement service company 3 reads out a payee authentication information registered in the data base in coordination with the identifier, and the payee authentication information read out is compared with the objective authentication information obtained to perform authentication for the payee.

The settlement service company 3 further confirms whether the inherent identifier attached to the valuable data intended for cashing is present in the valuable data circulation list or not. If not present, the valuable data having the inherent identifier come to have been already cashed, and so the current cashing is not practiced to give the candidate for cashing or the like notice of error.

Only when the candidate for cashing has been authenticated as a proper payee, and the fact that the inherent identifier is present in the valuable data circulation list has been confirmed, the proprietary right of the valuable data is transferred to the candidate for cashing by the settlement service company 3 (see arrow A25; proprietary right transferring step). Namely, the settlement service company 3 actually cashes the valuable data to deliver the money to the candidate for cashing, and deletes the corresponding inherent identifier from the valuable data circulation list.

At this time, the settlement service company 3 may put the money obtained by the cashing of the valuable data in the predetermined account or directly hands the money over to the candidate for cashing who has been authenticated as a proper payee. When the money is put in the predetermined account, there is no need for the candidate for cashing to go to the settlement service company 3 (teller's window or the like). Accordingly, the cashing of the valuable data can be performed on-line using WWW or the like, and convenience is enhanced. When the money is directly handed over to the candidate for cashing, the user of the e-purse C can save trouble of opening an account with a bank in advance with convenience.

[1-3-8] Escrow Service:

The escrow service in this embodiment will now be described in more detail. The escrow service means service that a reliable third party (in this embodiment, settlement service company 3) temporally keeps money upon a transaction between two things (in this embodiment, between customer 1 and receiver 2) unreliable on each other, thereby ensuring a secure transaction.

As described above, when the customer 1 uses escrow service, the settlement service company 3 issues valuable data at request of the customer 1 to attach it to the e-purse body C0 and moreover temporally keeps the money corresponding to the valuable data, which has been drawn out of the account of the customer 1, thereby maintaining the valuable data in a state that the valuable data cannot be immediately cashed.

Thereafter, the supplier 2 (candidate for cashing) cannot cash the valuable data unless the customer 1 informs the settlement service company 3 of the effect that the cashing of the valuable data attached to e-purse C is permitted. If a commodity that the customer 1 has received from the shop 2 is broken or different from a desired one, the customer 1 does not give notice of permitting the cashing of the valuable data, and so the supplier 2 cannot get money for ever.

When the commodity is returned after consultation between the customer 1 and the supplier 2, the customer 1 informs the settlement service company 3 of the effect that invalidating the valuable data is permitted (see arrow A 22), and the supplier 2 sends the e-purse C received from the customer 1 together with the owner authentication information (fingerprint data, password or the like) of the supplier 2 to the settlement service company 3 as an issuer of the pending valuable data to inform the settlement service company 3 of the effect that invalidating the valuable data is approved (see arrow A 23).

The settlement service company 3 confirms that the request is from the proper owner (proper payee) of the e-purse C on the basis of the owner authentication information, and then checks an identifier of the valuable data in the e-purse C received to confirm whether the identifier is present in the valuable data circulation list or not. When the fact that the supplier 2 who has approved invalidating is the proper owner, and the inherent identifier is present in the valuable data circulation list is confirmed, the settlement service company 3 returns the money temporally kept to the account of the customer 1 to increase money left in the account. Accordingly, when the customer 1 requests invalidating the valuable data, and the supplier 2 approves invalidating the valuable data, the money paid by the customer 1 comes to be returned to the account of the customer 1. After the settlement service company 3 returns the money for the valuable data, the inherent identifier is deleted from the valuable data circulation list.

If the customer 1 does not give notice of validating the valuable data, and the supplier 2 does also not approve invalidating the valuable data (request returning), the money corresponding to the valuable data remains kept by the settlement service company 3.

When the owner authentication information is stored in the e-purse C, and an issuer of the e-purse C (first settlement service company; for example, Bank A) is different from an issuer of the valuable data (second settlement service company; for example, Bank B), the second settlement service company cannot verify that a candidate for cashing is a proper owner (proper payee) of the e-purse C. In such a case, the second settlement service company transmits the e-purse C received and the owner authentication information to the first settlement service company to have the first settlement service company confirm that the request is from the proper owner. The case where the e-purse C is managed by at least two different settlement service companies will be described subsequently with reference to FIGS. 4 to 8.

The escrow service is generally performed in accordance with the steps (b1) to (b6) as described above. On the other hand, an exemplary managing process when the escrow service is applied to this embodiment is performed in accordance with the following steps (B1) to (B7):

(B1) A customer 1 down-loads an e-purse body C0 from a supplier 2 (see arrow A15).

(B2) The customer 1 attaches data of the details of order to the e-purse body C0 to send a settlement service company 3 it together with a customer ID, customer authentication information, the amount of the price to be paid (see arrow A16). The details of order may be attached to the e-purse body C0 in a step (B4), which will be described subsequently, not in the step (B2). When the details of order are attached in the step (B4), the details of order can be prevented from being known by the settlement service company 3.

(B3) The settlement service company 3 performs personal authentication for the customer 1 and temporally keeps the designated money drawn out of the contracted account of the customer 1. Valuable data corresponding to the designated money is prepared and put in an e-purse C. However, this valuable data is kept in a state that it cannot be cashed at this point of time. The settlement service company 3 returns and transmits the e-purse C to the customer 1 (see arrow A19).

(B4) The customer 1 confirms the contents (the amount of money put in, and the like) in the e-purse C received from the settlement service company 3 to transmit them to the supplier 2 (see arrow A20). At this time, the customer 1 prepares and stores a copy of the e-purse C.

(B5) The supplier 2 confirms the details of order stored in the e-purse C and the amount of money put in and then delivers a commodity to the customer 1 (see arrow A21).

(B6) The customer 1 confirms that the delivered commodity is the desired one and then transmits the effect that the cashing of the corresponding valuable data is permitted, a copy of the e-purse C, the customer ID and the customer authentication information to the settlement service company 3 (see arrow A22). Thereafter, the settlement service company 3 performs personal authentication for the customer 1 and then makes a state that the valuable data in the e-purse C can be cashed.

(B7) When a trouble has arisen between the supplier 2 and the customer 1, the valuable data is kept in a state that it cannot be cashed in the settlement service company 3 until the trouble is settled. When the customer 1 has come to return the commodity to the supplier 2, the customer 1 transmits the effect that the valuable data in the e-purse C is invalidated, the copy of the e-purse C, the customer ID and the customer authentication information to the settlement service company 3 (see arrow A22). The supplier 2 transmits the e-purse C received from the customer 1 together with the owner authentication information (fingerprint data, password or the like) of the supplier 2 to the settlement service company 3 as an issuer of the pending valuable data to inform the settlement service company 3 of the effect that invalidating the valuable data is approved (see arrow A 23). The settlement service company 3 confirms that the request is from the proper owner (proper payee) of the e-purse C on the basis of the owner authentication information, and then checks an identifier of the valuable data in the e-purse C received to confirm whether the identifier is present in the valuable data circulation list or not. When the fact that the supplier 2 who has approved invalidating is the proper owner, and the inherent identifier is present in the valuable data circulation list is confirmed, the settlement service company 3 perform personal authentication for the customer 1 and then invalidates the valuable data in the e-purse C to return the money temporally kept to the account of the customer 1 so as to increase money left in the account.

In the example described herein, the copy of the e-purse C is directly sent from the customer 1 to the settlement service company 3 upon the instructions of validating/invalidating the valuable data. However, control identifiers may be attached to respective valuable data to transfer instructions as to the specified valuable data between the customer 1 and the settlement service company 3 using its corresponding control identifier.

[1-3-9] Manner of Attaching Valuable Date to e-Purse Body:

In this embodiment, the valuable data is attached and joined to the e-purse C (e-purse body C0) by a payment process by the settlement service company 3 as described below. Users other than the proper payee can only attach and add the valuable data to the e-purse C (e-purse body C0), and cannot take any valuable data out of the e-purse C by itself. The valuable data cannot be cashed unless present with the e-purse body C0, and moreover only the proper payee registered in the e-purse body C0 can cash the valuable data. Namely, the e-purse C (e-purse body C0) according to this embodiment is so constituted that it has only a function of adding the valuable data to the electronic information body and does not have a function of taking out the valuable data.

In this embodiment, when the settlement service company 3 issues valuable data, an inherent identifier capable of being managed by the settlement service company 3 is assigned to the valuable data, and identifiers circulating in markets are managed by a valuable data circulation list.

By such function of the e-purse C and management by the valuable data circulation list, there is no need to build up a complicated system for security maintenance (prevention of duplicating, prevention of double use). This respect will hereinafter be described in detail.

According to the conventional systems used in on-line settlement, for example, the settlement system by e-money (eletronic money)/e-check (electronic check) and the settlement system by a credit card, great cost must be taken for a countermeasure to forgery. In particular, the e-money or e-check is easily duplicated because it is digital data. Various devices have heretofore been made for preventing such forgery.

(C1) Countermeasure to Forgery of e-money:

(C1-1) An e-money is stored in an IC card in such a manner that the stored data cannot be easily duplicated like an magnetic card.

(C1-2) An e-money is devised in such a manner that the data in the e-money can be rewritten only by a special reader/writer (read-write device).

(C1-3) An e-money is used only in a person to person transaction and not used in on-line settlement. Namely, the e-money (valuable data itself) is not circulated over the Internet.

(C1-4) the e-money data stored in the IC card is subjected to a ciphering treatment.

(C2) Countermeasure to Forgery of e-check:

(C2-1) An e-checkbook (electronic checkbook) is issued to a user (receiver, customer 1) by an e-check service company, and the user issues an e-check from the e-checkbook at any time. At this time, a sole identifier (serial number, management number) is attached to the e-check. The e-check service company keeps all serial numbers of e-checks cashed in past. In this case, as described in the item [c2-3], the e-check service company must semipermanentally store the identifiers of the e-checks cashed, and so the quantity of data of the identifiers to be stored in the data base is enormous. Accordingly, a memory having an extremely large capacity is required, and so great cost is required for building up the system.

(C2-2) Since everybody can cash an e-check, the e-check is easily cashed by a person who has stolen the e-check if stolen. If an e-check is stolen by, for example, tapping over the Internet before the e-check is cashed, there is no method for preventing the cashing of this e-check. It is also considered that an issuer of an e-check intentionally duplicates the e-check, and the duplicates thereof are transferred to a plurality of the objects of transactions. In this case, a supplier 2 or the like who has received the e-check delivers a commodity for the first time after the e-check is cashed, and so immediacy is lacking for delivery process. More specifically, the e-check itself may not become valuable data, and so the identifier or the like of the e-check must be confirmed in detail, or a device by which duplicating cannot be easily made (for example, exclusive protocol for delivery of e-check) must be developed or prepared.

(C3) Countermeasure to Forgery of Credit Card:

In settlement by a credit card, since a credit card number and the expiration of the credit card are basically only inputted, a dishonest act by guise is done with extreme ease. Thus, a credit card company effects an insurance to provide for the unfair use of a credit card.

In the settlement by the e-money, e-check or credit card, such devices as described above must be created.

In this embodiment, as described above, only a function of adding valuable data is given to the e-purse C, and moreover identifiers of valuable data circulating in markets are managed by the valuable data circulation list.

By doing so, there is avoided a necessity of building up a special system for countermeasure to duplicating of the e-purse C for the reasons (D1) to (D4) as described below. On the contrary, an environment that users can duplicate the e-purse to freely backup it can be provided, and so the users can have a feeling of ease to a great extent. (D1) Since respective valuable data are attached and joined to the e-purse body C0 as described below, users other than the proper payee cannot take individual valuable data out of the e-purse C, and so a duplicate-preventing me-chanism for each valuable data is unnecessary. The e-purse body C0 is always attended on the transfer of the valuable data. In the e-money or e-check, it can be transferred by itself.

(D2) Since the valuable data in the e-purse C is cashed only by a person (proper payee) consisting with the owner authentication information of the e-purse C, a third party cannot get money if the e-purse C is unfairly duplicated. On the contrary, the e-money or e-check can be cashed by everybody, and the credit card is unfairly used with ease by everybody.

(D3) Since only the addition of valuable data is permitted for the e-purse C, only new e-purse C makes sense. Namely, the past e-purse c duplicated is smaller in value (number of valuable data) than the new c-purse C and hence is of no utility value. Accordingly, the fact that the owner of the e-purse C uses a duplicate of the e-purse C to do a dishonest act is meaningless.

(D4) In this embodiment, the e-purse C of the customer 1 comes to always pass through a system on the side of the settlement service company 3 when the customer 1 pays the price to the supplier 2 by the e-purse C. Accordingly, the settlement service company 3 can attach an inherent identifier (management number) to all valuable data issued for and put in the e-purse C. More specifically, the settlement service company 3 keeps management numbers of valuable data circulating in markets in the valuable data circulation list and stores the management numbers of the valuable data cashed in the valuable data circulation list, whereby a system for checking the double use (double cashing) of the valuable data without retaining voluminous data to prevent the double use can be cheaply built up. Since the valuable data circulating in markets are always grasped by the valuable data circulation list on the side of the settlement service company 3, forged valuable data can be easily found if the proper payee prepares a copy of the e-purse C to make double use, and so it is impossible to cash the valuable data once cashed again.

A method of connecting and bonding (adding and retaining) valuable data to the e-purse C (e-purse body C0) will now be described specifically with reference to FIGS. 4 to 8.

When an electronic signature is prepared to the e-purse C upon retaining valuable data in the e-purse C, it is impossible to take only the valuable data out of the e-purse C. More specifically, the settlement service company 3 prepares an electronic signature for a portion containing the e-purse body C0 and the valuable data added at every time the valuable data is attached or added to the e-purse body C0 to attach it to the e-purse C, whereby it is impossible for a third party to alter the e-purse C, namely, the valuable data comes to be bonded to the e-purse C. Specific examples of the method of using the electronic signature to connect and bond the valuable data as described above are illustrated in FIGS. 4 to 6.

A first example of the method making use of the electronic signatures is shown in FIG. 4. In the first example, the settlement service company 3 prepares an electronic signature for all of the e-purse body C0, the valuable data already connected to this e-purse body C0 by the electronic signature and valuable data added to attach them to the e-purse C.

More specifically, in the example shown in FIG. 4, valuable data (first valuable data) corresponding to ¥2,000 issued by Bank A (first settlement service company) is first put in an empty e-purse C. At this time, the e-purse body C0 is connected to the first valuable data, and an electronic signature (electronic signature using a secret key owned by Bank A) of Bank A is attached to the whole thereof. Since the electronic signature is attached, alteration such as separation of the e-purse body C0 from the first valuable data becomes impossible. In other words, it is impossible to take only the first valuable data out of the e-purse C. In this example, the e-purse body C0 is issued by Bank A, and information as to Bank A is stored as issuer information in this e-purse body C0.

A case where valuable data (second valuable data) corresponding to ¥500 issued by Bank B (second settlement service company) is put in such an e-purse C as described above is considered. At this time, the second valuable data issued by Bank B is additionally connected to the e-purse C to which the first valuable data issued by Bank A has been attached. Thereafter, an electronic signature (electronic signature using a secret key owned by Bank B) of Bank B is attached to the whole of the e-purse body C0, first valuable data, the electronic signature of Bank A and second valuable data. Such electronic signatures are attached, whereby the second valuable data issued by Bank B, to say nothing of the first valuable data issued by Bank A, cannot be taken out of the e-purse C by itself.

A second example of the method making use of the electronic signatures is shown in FIGS. 5 and 6. In the first example described above, the electronic signature is attached to the whole of the e-purse C at every time valuable data is added. In the second example, however, the settlement service company 3 prepares an electronic signature for two of the e-purse body C0 and the valuable data added to attach it to the e-purse C.

More specifically, in the example shown in FIG. 5, when valuable data (first valuable data) corresponding to ¥2,000 issued by Bank A (first settlement service company) is first put in an empty e-purse C, an electronic signature (electronic signature using a secret key owned by Bank A) of Bank A for the e-purse body C0 and the first valuable data is prepared and attached. It is thereby impossible to take only the first valuable data out of the e-purse C. In this example as well, the e-purse body C0 is issued by Bank A, and information as to Bank A is stored as issuer information in this e-purse body C0.

When valuable data (second valuable data) corresponding to ¥500 issued by Bank B (second settlement service company) is put in such an e-purse C as described above, an electronic signature (electronic signature using a secret key owned by Bank B) of Bank B for the e-purse body C0 and the second valuable data is prepared and attached, whereby neither the first valuable data issued by Bank A nor the second valuable data issued by Bank B cannot be taken out of the e-purse C by itself. At this point of time, the e-purse C comes to be constituted by the e-purse body C0, the first valuable data issued by Bank A, the electronic signature of Bank A, the second valuable data issued by Bank B and the electronic signature of Bank B.

In FIG. 5, valuable data (third valuable data) corresponding to ¥10,000 issued by Bank A is further put in the e-purse C in which the first valuable data and the second valuable data have been put. At this time, an electronic signature of Bank A for the e-purse body C0 and the third valuable data is prepares and attached in the same manner as described above.

In the method shown in FIG. 5, since the valuable data in the e-purse C are not bonded to each other by the electronic signature, the individual valuable data can be separated from each other as illustrated in FIG. 6. Even when the individual valuable data are taken out, however, the valuable data cannot be separated from the e-purse body C0 because the object of the electronic signature is two of the e-purse body C0 and each valuable data. Namely, the e-purse body C0 must be duplicated when the valuable data is taken out. Accordingly, it is yet impossible for a third party to cash the valuable data by taking out only the valuable data by itself to put it in another e-purse.

In the examples shown in FIGS. 4 to 6, the electronic signature including the e-purse body C0 is prepared at every time the valuable data is added to realize the bonding of the e-purse C to the valuable data. However, it is also possible to realize the bonding of the e-purse C to the valuable data even by ciphering the valuable data with a specified public key. At this time, a secret key corresponding to the public key used in the ciphering is maintained and managed by at least one of the settlement service company 3 and the proper payee (supplier 2 who is an owner/manager of e-purse C in this embodiment). Specific examples of a method of connecting and bonding valuable data by using the public key in such a manner are illustrated in FIGS. 7 and 8, respectively.

In the examples shown in FIGS. 7 and 8, the e-purse body C0 is issued by Bank A, information as to Bank A is stored as issuer information in this e-purse body C0, and moreover the specified public key (ciphering public key) is also stored.

When valuable data (first valuable data) corresponding to ¥500 issued by Bank B (second settlement service company) is put in an empty e-purse C, the first valuable data is ciphered with a ciphering public key stored in the e-purse body C0 as shown in FIG. 7, and the ciphered first valuable data is attached to the e-purse body C0. When another valuable data is successively put in the e-purse C, it is only necessary to cipher such valuable data with the public key to attach it likewise. For example, when valuable data (second valuable data) corresponding to ¥500 issued by Bank A (first settlement service company) is put in the e-purse C shown in FIG. 7, the second valuable data is ciphered with a ciphering public key stored in the e-purse body C0 as shown in FIG. 8, and the ciphered second valuable data is attached to the e-purse body C0. Electronic signatures of the issuers are attached to the valuable data shown in FIGS. 7 and 8, respectively.

The secret key corresponding to the public key is maintained and managed by the settlement service company 3 or the supplier 2. Since the secret key is naturally required to correctly decode the valuable data ciphered as described above, a person who can substantiate the valuable data is limited to the settlement service company 3 or the supplier 2. At this time, when the secret key for decoding is maintained by the settlement service company 3 alone, a person who can substantiate the valuable data stored in the e-purse C to take out it is limited only to the settlement service company 3. Accordingly, any third party cannot take only the valuable data out of the e-purse C.

When the public key is stored in the e-purse body C0 as described above, the settlement service company 3 that performs the payment in the c-purse C can immediately get the public key to cipher the valuable data. At this time, when an electronic signature is further attached to the e-purse C, security can be more enhanced because the public key cannot be altered.

The secret key for decoding the valuable data may be stored in advance in a portable recording medium such as a memory card, and the supplier 2 who is a proper payee may possess and manage the portable recording medium. By doing so, reading of the valuable data, i.e., cashing can be made only by the owner of the portable recording medium in which the secret key has been stored.

In the examples shown in FIGS. 7 and 8, the ciphering public key is stored in the e-purse body C0. However, the ciphering public key may be obtained from a reliable institution (fiduciary institution) such as an official authentication institution or settlement service side at any time. In this case, an identifier is attached to the e-purse C, and the public key of the e-purse C is gained by using the identifier. By doing so, it is difficult to rewrite the public key by any third party, and so security is more enhanced.

In the examples shown in FIGS. 4 to 8, at least two valuable data are issued by at least two different settlement service companies (Bank A, Bank B) at request of the customer 1 and attached to one e-purse body C0. Namely, the e-purse C according to this embodiment is so constituted that a plurality of valuable data issued by different settlement service companies can be retained.

Thereby, flexibility of the transaction between the customer 1 and the supplier 2 is increased, and it is convenient for both customer 1 and supplier 2. In other words, there is no need for the customer 1 and the supplier 2 to use the same settlement service company 3. When valuable data such as e-checks issued by plural financial organs can be attached to one electronic information body C0 as described above, a manner of using the electronic information body C0 becomes identical with the general e-money, and so convenience (anonymity, environment used by everybody) comparable with the general e-money can be provided for users.

When two or more valuable data issued by different settlement service companies are contained in the e-purse C upon cashing of valuable data in the settlement service company 3, the settlement service company 3 collects money corresponding to the respective valuable data from the settlement service companies that are issuers of the respective valuable data. When the issuer of the e-purse C cashes the respective valuable data in cooperation with the respective settlement service companies, the payee (owner/manager of e-purse C) of the e-purse C does not need to negotiate with a plurality of settlement service companies, and it is convenient for the payee.

[1-3-10] Modifications of First Embodiment:

In the first embodiment described above, the settlement service company 3 issues the customer ID, password, etc. to deliver them to the customer 1 when the customer 1 makes a contract with the settlement service company 3 to provide for putting money in the c-purse C. At this time, the settlement service company 3 may prepare electronic information (e-checkbook) in which the amount of money payable by the user (customer 1) has been stored to deliver it in place of the customer ID.

The limited amount payable by the user (payable amount information) is always stored in the e-checkbook, and so the user can confirm the limited amount at any time. The putting of money in the cpurse C and electronic settlement using this e-checkbook is performed in accordance with the following steps (E1) to (E9):

(E1) A customer 1 makes a contract with a settlement service company 3 to open an account and then puts money in the account.

(E2) The settlement service company 3 issues an e-checkbook, in which the limited amount payable by the customer 1 (payable amount information) and ID have been stored, to give the customer 1 it. In the settlement service company 3, payee authentication information (personal authentication information of customer, owner authentication information) such as password or biometric information is determined and stored. At this time, the payee authentication information may also be ciphered and stored in the e-checkbook.

(E3) The customer 1 determines a purchase from a supplier 2.

(E4) The customer 1 confirms the e-checkbook on hand to confirm the money left in the account.

(E5) The customer 1 down-loads an e-purse body C0 from the supplier 2 to attach information such as the purchase to the e-purse body C0.

(E6) The customer 1 transmits the e-checkbook and the e-purse C to the settlement service company 3 together with the personal authentication information and the amount of money put to request the settlement service company 3 to attach valuable data having a value corresponding to the consideration necessary for the transaction to the e-purse body C0.

(E7) The settlement service company 3 performs personal authentication for the customer 1 and prepares valuable data corresponding to the designated amount of money to put it in the e-purse C. Besides, a new checkbook, in which the amount of left money payable by the customer 1 hereafter (payable amount information obtained by subtracting the amount corresponding to the value of the valuable data from the payable amount information of the e-checkbook) has been stored, is prepares. The e-purse C and the newly prepared e-checkbook are then transmitted to the customer 1.

(E8) The customer 1 confirms the e-purse C and e-checkbook received. The e-purse C is sent to the supplier 2. Hereafter, the old e-checkbook is annulled to use the new e-checkbook sent.

(E9) The supplier 2 confirms the details of the e-purse C to deliver a desired commodity.

At this time, the limited amount payable by the customer 1 (payable amount information) is always stored in the e-checkbook, and so the customer 1 can confirm the limited amount at any time. In other words, the customer 1 can always quickly confirm the money left on hand. Accordingly, the customer 1 does not need to take the trouble to access the settlement service company 3 to confirm the money left in one's own account, or to memorize the money left for oneself, and so the convenience to the customer 1 can be more enhanced. In the examples described above, the customer 1 puts money in the account in advance. However, a ordinary credit transaction by a credit card may be performed to determine the amount of money left to be stored in the e-checkbook from the solvency on the receiving side of the customer 1.

The valuable data attached to the e-purse body C0 may be one having at least one function of e-money, e-certificate, e-ticket and e-pass, and two or more different valuable data may be attached to one e-purse body C0. As described above, when an e-purse C is so designed that plural kinds of valuable data such as valuable data corresponding to money and valuable data corresponding to ticket can be stored therein, the customer 1 (or owner of e-purse) does not need to separately use a plurality of e-purses, and so the convenience of the customer 1 (or owner of e-purse) can be more enhanced. In addition, the owner thereof can be made clear. When the shop 2 delivers an e-ticket or e-pass as a commodity to the customer 1, the e-purse K (see FIG. 9) owned by the customer 1 may be used. A specific example thereof will be described in the subsequent second embodiment.

[1-4] Effects of First Embodiment:

As described above, in the electronic settlement method according to the first embodiment, the settlement service company 3 issues an e-purse C, by which the process of putting money therein can be performed by everybody, but the cashing (drawing of money therefrom) can be performed only by the owner, to the supplier (shop) 2. The greatest feature in the electronic settlement method according to the present invention resides in that such an e-purse C as described above is exchanged among the customer 1, shop 2 and settlement service company 3 (approver 4 as occasion demands) to perform a settlement.

The action and effects achieved by the electronic settlement method according to the first embodiment will hereinafter be described collectively.

[1-4-1] The e-purse C (e-purse body C0) owned by the shop 2 is exchanged among the customer 1, supplier 2 and settlement service company 3, whereby the customer 1 can electronically pay the consideration necessary for the transaction to the supplier 2 via the settlement service company 3. At this time, the customer 1 can directly control the payment of the price to the supplier 2, and so the customer 1 can perform the settlement feeling at rest, and e-commerce using the Internet can be activated to greatly increase sales.

[1-4-2] The settlement service company 3 can issue valuable data at the request of the customer 1, whereby the settlement service company 3 can grasp all valuable data circulating in markets, and so a method of maintaining the security of a system (double use-preventing system) can be simplified to cheaply build up the system.

[1-4-3] Since the settlement service company 3 attaches valuable data to the e-purse body C0 at the request of the customer 1, the settlement can be performed without intermediating the system of the supplier 2 at all. In addition, the supplier 2 does not need to inform the settlement service company 3 of the details of the transaction. Accordingly, it is entirely prevented that the supplier 2 (employee on the shop side) mistakes the amount claimed by operational mistake and that the customer 1 has one's money stolen by means of unfair practice (swindle or the like) of the supplier 2. It is also prevented that secret information such as credit card number or password is leaked to the supplier 2 upon transfer of the money and that the secret information is tapped or stolen over a network such as Internet.

[1-4-4] Since the supplier 2 does not need to inform the settlement service company 3 of the details of the transaction, the information of the customer 1 is not contained in the valuable data attached to the e-purse body C0, and thelectronic signature of the customer 1 is not used in electronic signature unlike an e-check, the privacy of the customer 1 is surely protected.

[1-4-5] Since the supplier 2 receives the e-purse C returned from the settlement service company 3, to which the valuable data-has been attached, the amount of money paid can be immediately confirmed to judge whether the customer 1 makes a mistake in inputting or malicious operation, or not, and so the time required to send a commodity can be shortened. The process of notifying the payment can be automated. Besides, the supplier 2 does not need to communicate with a credit company or the like at every transaction with the customer 1. Thus, the cost for building up an automation system can be controlled low.

[1-4-6] Since the cashing (transfer of proprietary right) of the valuable data attached to the e-purse body C0 can be performed only by a payee oneself (supplier 2 who is an owner/manager of e-purse C in this embodiment) registered in the e-purse body C0 in advance, the cashing cannot be performed if another person than the payee oneself intends to cash the valuable data by stealing or duplicating the e-purse C containing the valuable data. Accordingly, unfair cashing can be surely prevented.

[1-4-7] Issuer information as to the issuer (settlement service company 3) of the e-purse body C0 is stored in this e-purse body confirmably from the outside, whereby everybody can confirm the issuer of the e-purse body C0. It is thereby ensured that the valuable data attached to the e-purse body C0 can be certainly cashed, and so a feeling of ease can be given to a user (receiver 2).

[1-4-8] The valuable data is attached to the e-purse body C0 confirmably from the outside, whereby everybody [customer 1, supplier 2, third party (approver 4)], who has received the e-purse C, can confirmed the details (amount of money put in) of the valuable data upon returning the e-purse body C0, to which the valuable data has been attached, form the settlement service company 3 to the supplier 2.

[1-4-9] The e-purse body C0, to which the valuable data has been attached, is returned from the settlement service company 3 to the supplier 2 via the customer 1, whereby the customer 1 can finally confirm the amount of money paid before the e-purse C is returned to the supplier 2 to judge whether the amount of money put in is correct or not. At this time, since the supplier 2 directly receives the e-purse C, to which the valuable data has been attached, from the customer 1, the amount of money put in can be immediately confirmed, and so the time required to send a commodity can be shortened to a great extent.

[1-4-10] The e-purse body C0, to which the valuable date has been attached, is returned from the settlement service company 3 to the supplier 2 via at least one third party, for example, approver 4, other than the customer 1 registered in advance, whereby the approver 4 can finally confirm the amount of money to be paid before the e-purse C is returned to the supplier 2 to judge whether the amount of money put in is correct or not. This is effective in a case where another approver of purchasing is present like the case where the customer 1 and an actual payer of the consideration are different from each other. Since the payer can check the details of the transaction independent of the receiver (customer 1), occurrence of unexpected payment attended on, for example, a transaction which is performed under the guise of the receiver 1 can be monitored, and the practice of the payment for such a transaction can be surely prevented.

Since in payment by a credit card, a person who knows the credit card number thereof can freely purchase a commodity, the user of the credit card attempts not to let other persons know the credit card number or the like. However, there is a possibility that an abuse may be made if the credit card number or the like is known. On the other hand, when the approver 4 always checks the details of the purchase independent of the customer 1 as described in this embodiment, unexpected payment attended on abuse of the customer ID and customer authentication information can be surely prevented if the customer ID and customer authentication information transmitted from the customer 1 to the settlement service company 3 have been known by other persons due to tapping/theft and abused.

[1-4-11] The destination where the e-purse C will be returned or routed is registered in advance on the side of the settlement service company 3, and the e-purse C is returned from the settlement service company 3 to the registered destination or the regitered site on the route, whereby it is difficult to unfairly change the destination or the via-site where the e-purse C will be returned or routed. Accordingly, the customer 1 can put money (add valuable data to) in the e-purse body C0 feeling at rest. When the e-purse C is directly returned to the supplier 2, the e-purse C is surely returned to the supplier 2, and so it is prevented that the e-purse C is transferred to a third party to unfairly cash the valuable data and that the transaction is hindered. Thus, the customer 1 can pay the money to the supplier 2 feeling at rest.

[1-4-12] The destination where the e-purse C will be returned or routed is stored in advance in the e-purse C, and the e-purse C is returned from the settlement service company 3 to the stored destination or the stored site on the route, whereby a user (customer 1, supplier 2 or approver 4) can confirm the destination or the via-site where the e-purse C will be sent by oneself. When the e-purse C is directly returned to the supplier 2, the customer 1 can have a feeling of ease because the destination to be paid becomes clear. In addition, the supplier 2 can confirm whether the e-purse C is certainly returned to one's destination or not.

[1-4-13] The information for authentication stored in the e-purse body C0 is used as information for authentication of a payee (owner authentication information; for example, biometric information or password itself) to be checked with the objective authentication information obtained from the candidate for the receipt of the valuable data upon the authentication of this candidate, whereby a coordinating relation between a payee (supplier 2 who is the owner of the e-purse C) and the e-purse body C0 can be certainly established, and only the payee oneself can cash the valuable data. At this time, the anonymity of the e-purse C is retained because authentication information (payee authentication information itself) is only stored in addition to the issuer information, return destination and ciphering w public key as illustrated in FIGS. 2 to 8. Since the payee authentication information is stored in the e-purse body C0, there is no need of a system for managing the payee authentication information.

[1-4-14] An identifier inherent in the e-purse body C0 is stored as the information for authentication in the e-purse body C0 in advance, and information for authentication of a payee (biometric information or password itself) to be checked with the objective authentication information obtained from the candidate for the receipt of the valuable data upon the authentication of this candidate is owned by the settlement service company 3 in coordination with the inherent identifier, whereby only the payee oneself can cash the valuable data. At this time, since the payee authentication information is owned on the side of the settlement service company 3, and the inherent identifier is only stored in the e-purse body C0, unfair cashing by rewriting of the payee authentication information can be surely prevented. In this case as well, the anonymity of the e-purse C is retained because authentication information (identifier inherent in the e-purse body C0) is only stored in addition to the issuer information, return destination and ciphering public key as illustrated in FIGS. 2 to 8.

[1-4-15] Data of the inherent identifier and the payee authentication information (biometric information or password itself) in coordination with each other are stored in a portable recording medium in place of being kept in the settlement service company 3, whereby the portable recording medium can be owned and managed by the payee of the e-purse body C0, and so there is no need to manage the payee authentication information on the side of the settlement service company 3. When biometric information is used as the payee authentication information, the privacy of the payee authentication information can be advantageously managed by oneself.

[1-4-16] A character string is used as the payee authentication information (owner authentication information), whereby the same system as the personal authentication by the password system heretofore widely used can be adopted. The personal authentication system is easy to accepted by users.

On the other hand, the biometric information of the payee oneself is used as the payee authentication information (owner authentication information), whereby the personal authentication for the payee can be surely performed, and the security is enhanced. In addition, there is no need for the payee to store the payee authentication information like the password, and there is no need to particularly manage the payee authentication information.

[1-4-17] The payee is registered as an owner of the e-purse body C0 or a manager for managing the supplier 2, and the authentication information of the owner or manager is registered as payee authentication information, whereby a coordinating relation between the owner or manager and the e-purse body C0 can be certainly established, and only the owner or manager oneself can cash the valuable data.

[1-4-18] Information transmission among the customer 1, supplier 2 and settlement service company 3 is carried out by at least one of wire communication means and radiocommunication means, whereby immediacy is enhanced, and the electronic settlement system can be comfortably utilized. On the other hand, information transmission among the customer 1, supplier 2 and settlement service company 3 is carried out by means of exchange of a portable recording medium, whereby the electronic settlement system can be used even in off-line, and there is no need to arrange communication environment.

[1-4-19] The settlement service company 3 performs confirmation of practice on the attachment of the valuable data with a confirmation destination including the customer 1 and a preregistered third party (approver 4), whereby unfair transfer of money is ascertained in advance if such a fact is intended to be practiced, and the unfair transfer of money can be prevented, and so security can be more enhanced. At this time, when the confirmation destination is registered in advance on the side of the settlement service company 3, it is difficult for an offender or the like to rewrite the confirmation destination in such a manner that the unfair transfer of money is not detected. When the confirmation destination is stored in the e-purse C (e-purse body C0) in advance, the confirmation destination for the transfer of money can be flexibly changed at every use of the e-purse C (e-purse body C0).

[1-4-20] Money is kept in advance in the account of the customer 1 on the side of the settlement service company 3, and the settlement service company 3 draws the amount of money corresponding to the valuable data attached to the e-purse body C0 out of the account, whereby the settlement service company 3 can make payment for the e-purse body C0 using the money kept from the customer 1 in advance, and so trouble of collecting money from the customer 1 is saved, and moreover there is no risk of failing to recover money corresponding to the amount of money paid from the customer 1.

[1-4-21] The settlement service company 3 temporally keeps money drawn out of the account of the customer 1 and cashes the valuable data by permission of the customer 1 or returns the money temporally kept to the account of the customer 1 when the customer 1 does not permit, whereby the settlement service company 3 can provide escrow service (third party intermediation) for a transaction between the customer 1 and the supplier 2.

[1-4-22] When the customer 1 requests the settlement service company 3 to annul the valuable data, the settlement service company 3 returns the money temporally kept to the account of the customer 1 with supplier's approval as to the revocation of the valuable data, whereby the money kept by the settlement service company 3 cannot be returned to the account of the customer 1 unless both customer 1 and supplier 2 approve, and so the security of the supplier 2 is also maintained.

[1-4-23] The customer 1 makes a contract with the settlement service company 3 in advance, and the settlement service company 3 pays the amount of money corresponding to the valuable data attached to the e-purse body C0 for the customer 1, and claims the money paid for the customer 1 to the customer 1 in the future, whereby the customer 1 can put the money in the e-purse body C0 without caring about the money left, and so advantage is given to the customer 1. Since this method is the same system as the conventional credit card service, the existing credit card service may be used as it is.

[1-4-24] The function of the e-purse body C0 capable of being used by users other than the proper payee is limited only to a function of attaching or adding valuable data to the e-purse body C0, whereby the building up of a system for security maintenance (prevention of duplicating, prevention of double use) is scarcely necessitated in cooperation with the fact that the settlement service company 3 can manage all valuable data circulating in markets and that only the payee oneself can cash the valuable data. On the contrary, an environment that the e-purse C including the valuable data can be duplicated to freely backup it can be provided for users, and so the users can have a feeling of ease to a great extent. Since any duplicate-preventing technique as to the e-purse C, to which the valuable data has been attached, becomes unnecessary, the e-purse C can be exchanged with extreme ease among the customer 1, supplier 2 and settlement service company 3, for example, by attaching it to an e-mail.

[1-4-25] The settlement service company 3 prepares an electronic signature for a portion containing the e-purse body C0 and the added valuable data at every time the valuable data is attached or added to the e-purse body C0 to attach it to the e-purse C, whereby it is impossible to unfairly take only the valuable data out of the e-purse C, and so a third party can unfairly cash the valuable data attached to the e-purse body C0.

[1-4-26] An electronic signature of an issuer of the e-purse body C0 is attached to the e-purse body C0, or, when the customer 1 adds additional information to the e-purse body C0, an electronic signature for the e-purse body C0 and the additional information is prepared to attach it to the e-purse body C0, whereby it is impossible for a third party to alter the various kinds of information stored in the e-purse body C0, and so security is enhanced.

[1-4-27] The valuable data attached to the e-purse body C0 is ciphered by an appointed public key, and a secret key corresponding to the public key is managed by at least one of the settlement service company 3 and a payee, whereby a person who can substantiate (cash) the valuable data is limited to the settlement service company 3 or a payee (owner or manager of the e-purse body C0; receiver 2 in this embodiment) because the secret key is required to correctly decode the valuable data.

[1-4-28] The valuable data attached to the e-purse body C0 is ciphered by an appointed public key, and a payee (owner or manager of the e-purse body C0; receiver 2 in this embodiment) possesses a portable recording medium in which a secret key corresponding to the public key has been stored, whereby reading of the valuable data, i.e., cashing can be made only by the owner (payee) of the recording medium in which the secret key has been stored.

[1-4-29] When a public key used in the ciphering of the valuable data is stored in the e-purse body C0, the settlement service company 3 that performs the payment for the e-purse body C0 can immediately get the public key to cipher the valuable data. At this time, when an electronic signature is attached to the e-purse body C0, security can be ensured because the public key cannot be altered. On the other hand, when a public key used in the ciphering of the valuable data is obtained from a fiduciary institution at any time, security can be enhanced because it is difficult to rewrite the public key by any third party.

[1-4-30] An electronic signature of the settlement service company 3 is attached to the valuable data attached to the e-purse body C0 as shown in FIGS. 7 and 8, whereby it can be prevented to rewrite the valuable data by those other than the settlement service company 3 that is an issuer of the valuable data.

[1-4-31] The settlement service company 3 transfers money to the appointed account upon cashing of the valuable data, whereby a payee oneself (supplier 2 who is the owner/manager of the e-purse body C0) can conveniently perform cashing on-line using WEB or the like without going to a teller's window. On the other hand, the settlement service company 3 delivers money by hand to a candidate for the receipt, who has been authenticated as the payee oneself, upon cashing of the valuable data, whereby the payee does not need to open an account with a bank in advance, and so trouble can be advantageously saved.

[1-4-32] In the electronic settlement method according to this embodiment, the process of putting money in the e-purse C is always performed by the system on the side of the settlement service company 3. Accordingly, the settlement service company 3 can respectively apply their inherent identifiers (management numbers) to all valuable data issued by the settlement service company 3. In other words, the settlement service company 3 keeps and manages the identifiers of valuable data circulating in markets by the valuable data circulating list, whereby all valuable data issued by the settlement service company 3 among the valuable data circulating in the markets can be grasped. At this time, when an identifier applied to the intended valuable data for cashing is kept in the valuable data circulating list of the settlement service company 3, the proprietary right of this valuable data is transferred to a candidate for the receipt of the valuable data, in other words, the valuable data is cashed. Thereby, check of double cashing can be realized with a cheap system, and besides forged valuable data can be found with extreme ease.

[1-4-33] Any data (for example, at least one of date, time, name of customer 1, address of customer 1, telephone number of customer 1, e-mail address of customer 1, reason for payment of consideration, amount of money of consideration, delivery destination of a commodity dealt with in transaction and e-purse body owned by customer 1) is attached to the e-purse body C0, whereby there is no need for the customer 1 to separately send the details of order, or the like to the supplier 2, and so the convenience to users (receivers and suppliers) is enhanced, and a coordinating relation between the details of receipt of money and the details of order in the e-purse body C0 is made clear, and management by the supplier 2 becomes easy.

[1-4-34] The e-purse body C0 owned by the supplier 2 is open to the general public in such a manner that the customer 1 can get the e-purse body C0 opened to the general public, whereby the customer 1 can obtain the e-purse body C0 when necessary to make order. Specifically, the supplier 2 does not need to individually contact with each customer 1 so as to give the customer 1 the e-purse body C0.

[2] Second Embodiment:

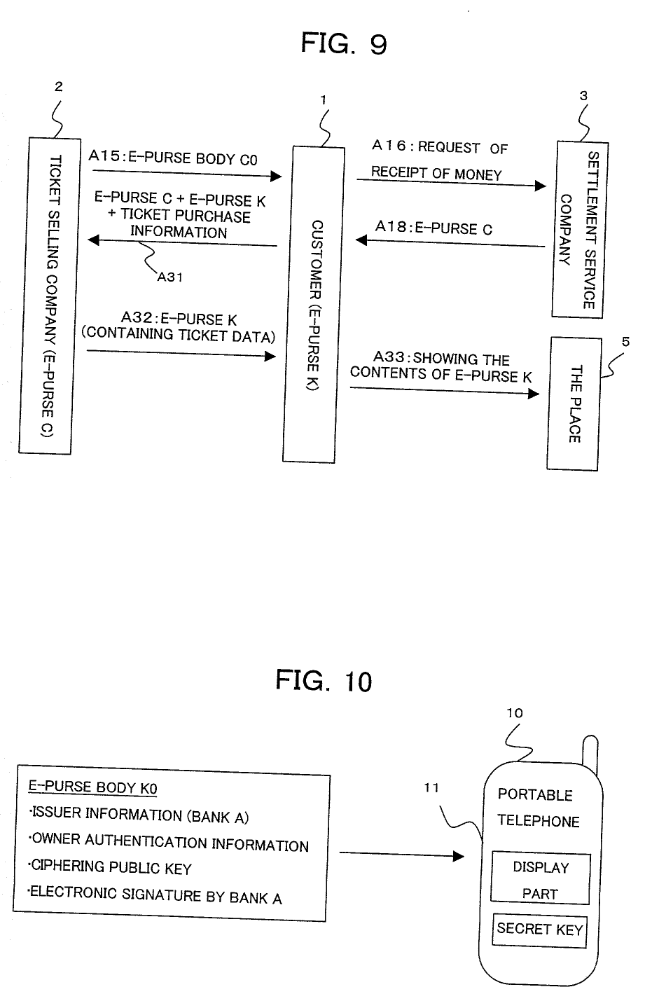

FIG. 9 is a diagram illustrating the constitution of a system, to which an electronic settlement method according to a second embodiment of the present invention is applied, and the procedure of this method, and FIG. 10 is a diagram illustrating a manner of using an e-ticket (e-pass) according to the second embodiment.

In the second embodiment of the present invention, an e-purse (electronic information for transmission of valuable data) K owned by a customer 1 is stored in a portable telephone (portable information terminal; see reference character 10 in FIG. 10) and carried together with this portable telephone 10 to use it. In this e-purse K, is put, as valuable data, admission tickets (e-ticket, e-pass) and various kinds of discount tickets.

In this second embodiment, when a customer 1 purchases an e-ticket, the payment for a ticket selling company (supplier 2) is performed in accordance with the procedure described above in the first embodiment using an e-purse C owned by the ticket selling company as illustrated in FIG. 9, and the transfer of the ticket to the customer 1 from the ticket selling company 2 is performed using an e-purse K owned by the customer 1 (see arrow A32 in FIG. 9). The e-ticket-containing e-purse K is stored in a portable telephone 10, and the contents in the e-purse K are displayed on the display part 11 (see FIG. 10) of the portable telephone 10, whereby the e-purse K is used for personal certification (possessions authentication) upon entrance into the place 5 of meeting.

The procedure until the customer 1 purchases the e-ticket from the ticket selling company 2 that is a supplier and enters the place 5 of meeting will hereinafter be described with reference to FIGS. 9 and 10. In the second embodiment, 2 e-purses of the e-purse C owned by the ticket selling company 2 and the e-purse K owned by the customer 1 are exchanged. Here, the e-purse K of the customer 1 is issued to the customer 1 in the same manner as in the e-purse C owned by the supplier 2 as described above in the first embodiment.

The ticket selling company 2 and customer 1 have some settlement service company issue the e-purses C and K respectively owned by them to possess them. These e-purses C and K are issued in the same manner as in the first embodiment. As illustrated in FIG. 10, however, issuer information (information as to Bank A in this embodiment), owner authentication information (payee authentication information; authentication information for the customer 1 in this embodiment) and a ciphering public key valuable data (e-ticket or the like) are stored in the e-purse body (electronic information body for transmission of valuable data) K0, and an electronic signature of Bank A (settlement service company 3) that is an issuer is further attached thereto. A decoding key (secret key corresponding to the ciphering public key) for decoding the ciphered valuable data is stored in advance in the portable telephone 10 in which the e-ticket-containing e-purse K will be stored.

The customer 1 gets an e-purse body C0 from the ticket selling company 2 by down-load over WWW or the like (see arrow A15 in FIG. 9). The customer 1 transmits the e-purse body C0 to the settlement service company 3 together with the customer ID, customer authentication information (personal authentication information such as fingerprint data or password) and amount of money to be received (see arrow A16 in FIG. 9). The settlement service company 3 performs personal authentication for the customer 1 using the customer ID and the customer authentication information and prepares valuable data corresponding to the appointed amount of money to connect it to (put it in) the e-purse C. Thereafter, the e-purse C, in which the money has been put, is returned to the customer 1 (see arrow A18 in FIG.9). The process for putting money in the e-purse C described above is the same as the process described in the first embodiment.

The customer 1 then sends the e-purse C the ticket selling company 2 (see arrow A31 in FIG. 9) to purchase a desired ticket. At this time, the customer 1 receives the e-ticket using one's own e-purse K (see arrow 32 in FIG. 9). The detailed process at this time will hereinafter be described.

The customer 1 prepares information as to a ticket wanted to purchase, and sends the ticket selling company 2 the e-purse C, in which the money has been put (or to which the valuable data has been attached), together with the purchase information and the e-purse body K0 (see arrow A 31 in FIG. 9).

The ticket selling company 2 takes the valuable data, purchase information and e-purse K out of the e-purse C received. The electronic signature of the valuable data is confirmed to confirm the availability of the valuable data. The electronic signature of the issuer of the e-purse body K0 is then confirmed to confirm that this e-purse body K0 is one issued by a reliable institution or corporation. Thereafter, valuable data (e-ticket) corresponding to a ticket is prepared according to the purchase information. The current valuable data may be data containing, for example, an ticket image or bar code, details of promotion, and/or the like. After the electronic signature of the ticket selling company 2 is attached to the valuable data thus prepared, the valuable data is ciphered with the public key stored in the e-purse body K0, and the ciphered valuable data is connected to the e-purse body K0. The ticket selling company 2 returns the e-purse K, in which the e-ticket has been put in the above-described manner, to the portable telephone 10 of the customer 1 via e-mail or the like (see arrow A 32 in FIG. 9).

When the customer 1 receives the e-purse K containing the e-ticket by the portable telephone 10, the e-purse K is always carried by keeping it in the portable telephone 10. When the above-described serial process is wholly performed by data communication through the portable telephone 10, the customer 1 can conveniently perform on-line shopping by means of the portable telephone 10 alone even when a terminal for performing on-line settlement, such as a personal computer, is not possessed.

When the customer 1 enters the place 5 of meeting, the e-ticket as the valuable data is taken out of the e-purse K stored in the portable telephone 10 to decode it with the secret key stored in the portable telephone 10. When the decoded e-ticket is, for example, a ticket image, it is displayed on the display part 11 of the portable telephone 10, and the customer 1 submits the image with a staff at the place 5 of meeting to enter the place 5 of meeting (see arrow A 33 in FIG. 9). When the decoded e-ticket is, for example, a bar code image, it is displayed on the display part 11 of the portable telephone 10, and the customer 1 enter the place 5 of meeting after the customer 1 has the bar code image read by means of a bar code scanner by a staff at the place 5 of meeting to be subjected to judgment of admission. After the e-ticket is used in such a manner, the customer 1 annuls the e-purse K.

In this embodiment, the ticket selling company 2 gives the customer 1 the e-ticket utilizing the e-purse K. The reason why the e-purse K is utilized in such a manner will hereinafter be described.

The ticket selling company 2 most fears forgery and ticket-scalping in ticket sale. The same shall apply to the on-line sale. Accordingly, a device for preventing these unfair acts must be provided. When an e-ticket (valuable data) obtained by making a ticket electronic data like the e-money or e-check is exchanged with a customer as it is, it is easily forged. A device for limiting a person (customer) who can use the e-ticket in such a manner that the e-ticket cannot be forged or the forgery is meaningless is required. In other words, a device for correlating the e-ticket with the customer in such a manner that other persons than the customer cannot use the e-ticket is required.

The e-purse K owned by the customer 1 is utilized for realizing such a device. As described in the first embodiment, the e-purse K proposed in this embodiment intends to provide a device in which it naturally possesses valuable data, and the cashing of the valuable data can be performed only by the owner oneself of the valuable data. In other words, the e-purse K is closely correlated with the customer 1. When an e-ticket is connected to this e-purse K, the e-ticket is consequently closely correlated with the customer 1, which can make the e-ticket unusable by persons other than the customer 1.

The ticket selling company 2 verifies whether the e-purse K of the customer 1 is issued by a reliable settlement service company or not from the electronic signature of the e-purse body K0 to judge whether the e-purse K is closely correlated with the owner of the e-purse K or not. A public key for ciphering the valuable data is stored in the e-purse body K0, and a secret key for decoding the ciphered valuable data is stored in the portable telephone 10. In other words, the confirmation of the contents of the e-purse K is limited to a person who has the portable telephone 10. If the e-purse K is stolen or duplicated, the e-ticket can be correctly decoded only by the person who has the portable telephone 10. Accordingly, the forgery of the e-ticket and ticket-scalping can be prevented.

In order to realize this, an environment that the secret key cannot be duplicated must be provided. This can be realized by storing the secret key stored in the portable telephone 10 in a region in which writing can be made only by a particular person (device). For example, the secret key is written in advance in a region incapable of rewriting in the portable telephone 10 upon fabrication of the portable telephone 10, and the portable telephone 10 is sold together with the public key thereof. In this case, it is only necessary for the customer 1 to make a contract with a settlement service company to prepare the e-purse K with the public key attached to the portable telephone 10 upon the preparation of the e-purse body K0. The e-purse K and the portable telephone 10 are closely correlated with each other via the public key and secret key.

As another example, the settlement service side that the e-purse K is issued may give the customer 1 a memory card, in which the secret key has been stored, in such a manner that the valuable data can be decoded only by installing this card in the portable telephone 10. At this time, when a device that the preparation of the memory card can be made only by the settlement service side is provided, the security of the e-purse K is maintained.

According to the second embodiment of the present invention, as described above, the ticket selling company 2 sends the customer 1 the e-ticket or e-pass attached to the e-purse K owned by the customer 1, whereby the commodity can be delivered to customer 1 with certainty and security. At this time, the e-purse body K0 owned by the customer 1 can be attached to the e-purse C when the e-purse C returned from the settlement service company 3 to the ticket selling company 2 goes via the customer 1, whereby the customer 1 can deliver the e-purse body K0 to the ticket selling company 2 with extreme ease.

When the customer 1 receives the e-purse K to which the e-ticket or e-pass has been attached, the e-ticket or e-pass can be used by displaying the details of the e-ticket or e-pass to submit them with a staff or the like. In particular, when the e-purse K to which the e-ticket or e-pass has been attached is received by the portable telephone 10, the e-ticket or e-pass can be used with extreme ease by displaying the details of the e-ticket or e-pass on the display part 11 of the portable telephone 10 to show the desplay part 11 to a staff or the like.

[3] Others:

The present invention should by no means be limited to these foregoing embodiments, and various changes or other modifications may be suggested without departing from the gist of the invention.

What is claimed is:

1. An electronic settlement method for electronically paying the consideration necessary for a commercial transaction by a receiver to a supplier via a settlement service provider upon the transaction between the receiver and the supplier, said method comprising the steps of:
obtaining and possessing an electronic information body for transmission of valuable data by the supplier, the electronic information body having a function of holding the valuable data and being recorded therein information for authentication required for authenticating a payee of the valuable data in advance;
obtaining the electronic information body, which is owned by the supplier, by the receiver (hereinafter referred to as “obtaining step”);
transmitting the electronic information body from the receiver to the settlement service provider to request to attach valuable data having a value corresponding to the consideration necessary for the transaction to the electronic information body (hereinafter referred to as “requesting step”);
attaching the valuable data to the electronic information body at the request of the receiver after authenticating the receiver by the settlement service provider (hereinafter referred to as “attaching step”);
returning electronic information for transmission of valuable data composed of the electronic information body and the valuable data from the settlement service provider to the supplier (hereinafter referred to as “returning step”); and
transferring the proprietary right of the valuable data in the electronic information for transmission of valuable data to a candidate for the receipt of the valuable data by the settlement service provider only when the candidate has been authenticated as a payee oneself of the valuable data on the basis of the information for authentication stored in the electronic information body (hereinafter referred to as “proprietary right transferring step”).

2. The method according to claim 1, wherein issuer information as to the issuer of the electronic information body is stored in advance in the electronic information body confirmably from the outside.

3. The method according to claim 1, wherein the valuable data is attached to the electronic information body confirmably from the outside.

4. The method according to claim 3, wherein in the returning step, the electronic information is returned to the supplier via the receiver.

5. The method according to claim 3, wherein in the returning step, the electronic information is returned to the supplier via at least one third party other than the receiver registered in advance.

6. The method according to claim 1, wherein a destination where the electronic information for transmission of the valuable data should be returned is registered in advance on the settlement service provider side, and
in the returning step, the electronic information is returned from the settlement service provider to the destination registered in advance on the settlement service provider side.

7. The method according to claim 1, wherein a destination where the electronic information for transmission of the valuable data should be returned is stored in advance in the electronic information, and
in the returning step, the electronic information is returned from the settlement service provider to the destination stored in advance in the electronic information.

8. The method according to claim 1, wherein route information when the electronic information for transmission of the valuable data will be returned is registered in advance on the settlement service provider side, and
in the returning step, the electronic information is returned from the settlement service provider to the supplier via a site according to the route information registered in advance on the settlement service provider side.

9. The method according to claim 1, wherein route information when the electronic information for transmission of the valuable data will be returned is stored in advance in the electronic information, and
in the returning step, the electronic information is returned from the settlement service provider to the supplier via a site according to the route information stored in advance in the electronic information.

10. The method according to claim 1, wherein the information for authentication is information for authentication of a payee to be checked with the objective authentication information obtained from the candidate for the receipt of the valuable data upon the authentication of said candidate.

11. The method according to claim 1, wherein the electronic information body is issued by the settlement service provider,
an identifier inherent in the electronic information body is stored as the information for authentication in the electronic information body in advance, and
information for authentication of a payee to be checked with the objective authentication information obtained from the candidate for the receipt of the valuable data upon the authentication of this candidate is owned by said settlement service provider in coordination with said identifier.

12. The method according to claim 1, wherein the electronic information body is issued by the settlement service provider,
an identifier inherent in the electronic information body is stored as the information for authentication in the electronic information body in advance, and
information for authentication of a payee to be checked with the objective authentication information obtained from the candidate for the receipt of the valuable data upon the authentication of said candidate is stored in a portable recording medium in coordination with said identifier.

13. The method according to claim 10, wherein the payee authentication information is a character string.

14. The method according to claim 11, wherein the information for authentication of the payee is a character string.

15. The method according to claim 12, wherein the information for authentication of the payee is a character string.

16. The method according to claim 10, wherein the information for authentication of the payee is biometric information obtained from the payee oneself.

17. The method according to claim 11, wherein the information for authentication of the payee is biometric information obtained from the payee oneself.

18. The method according to claim 12, wherein the information for authentication of the payee is biometric information obtained from the payee oneself.

19. The method according to claim 1, wherein the payee is an owner of the electronic information body.

20. The method according to claim 1, wherein the payee is a manager for managing the supplier.

21. The method according to claim 1, wherein information transmission among the receiver, supplier and settlement service provider is carried out by at least one of wire communication means and radiocommunication means.

22. The method according to claim 1, wherein information transmission among the receiver, supplier and settlement service provider is carried out by means of exchange of a portable recording medium.

23. The method according to claim 1, wherein the settlement service provider performs confirmation of practice on said attaching step with a confirmation destination including the receiver or a preregistered third party other than the receiver prior to the attaching step.

24. The method according to claim 23, wherein the confirmation destination is registered in advance on the settlement service provider side.

25. The method according to claim 23, wherein the confirmation destination is stored in the electronic information for transfer of valuable data.

26. The method according to claim 1, wherein the receiver opens an account on the settlement service provider side to keep money in the account in advance, and
when the valuable data is attached to the electronic information body in said attaching step, the settlement service provider draws the amount of money corresponding to the attached valuable data out of the account.

27. The method according to claim 26, wherein the settlement service provider temporally keeps the money drawn out of the account of the receiver,
the settlement service provider practices said proprietary right transferring step when the receiver permits the settlement service provider to cash the valuable data, and
the settlement service provider returns the money temporally kept to the account when the receiver request the settlement service provider to invalidate the valuable data.

28. The method according to claim 27, wherein when the receiver requests the settlement service provider to invalidate the valuable data, the settlement service provider returns the money temporally kept to said account with approval of the supplier, who is an owner of the electronic information body, as to the annulment of the valuable data.

29. The method according to claim 1, wherein the receiver makes a contract with the settlement service provider in advance, and
the settlement service provider pays the amount of money corresponding to the valuable data for the receiver when the valuable data is attached to the electronic information body in said attaching step.

30. The method according to claim 1, wherein the function of the electronic information body capable of being used by users other than the proper payee is limited only to a function of attaching or adding valuable data to the electronic information body.

31. The method according to claim 30, wherein the settlement service provider prepares an electronic signature for a portion containing the electronic information body and the added valuable data at every time the valuable data is attached or added to the electronic information body in said attaching step to attach it to the electronic information for transmission of valuable data.

32. The method according to claim 31, wherein the settlement service provider prepares an electronic signature for the whole of the electronic information body, the valuable data already attached to the electronic information body by the electronic signature and the added valuable data to attach it to the electronic information for transmission of valuable data.

33. The method according to claim 31, wherein the settlement service provider prepares an electronic signature for the electronic information body and the added valuable data to attach it to the electronic information for transmission of valuable data.

34. The method according to claim 1, wherein an electronic signature of an issuer of the electronic information body is attached to said electronic information body.

35. The method according to claim 1, wherein when the receiver adds additional information to the electronic information body, an electronic signature for the electronic information body and the additional information is prepared to attach it to said electronic information body.

36. The method according to claim 1, wherein the valuable data attached to the electronic information body in said attaching step is ciphered by an appointed public key, and a secret key corresponding to the appointed public key is managed by at least one of the settlement service provider and the payee.

37. The method according to claim 1, wherein the valuable data attached to the electronic information body in said attaching step is ciphered by an appointed public key, and the payee possesses a portable recording medium in which a secret key corresponding to the public key has been stored.

38. The method according to claim 36, wherein the appointed public key is stored in the electronic information body.

39. The method according to claim 37, wherein the appointed public key is stored in the electronic information body.

40. The method according to claim 36, wherein the appointed public key is obtained from a fiduciary institution.

41. The method according to claim 37, wherein the appointed public key is obtained from a fiduciary institution.

42. The method according to claim 1, wherein an electronic signature by the settlement service provider is attached to the valuable data attached to the electronic information body in said attaching step.

43. The method according to claim 1, wherein, in the proprietary right transferring step, the valuable data is cashed and the cashed money corresponding to the valuable data is transferred to an appointed account.

44. The method according to claim 1, wherein, in said proprietary right transferring step, the valuable data is cashed and the cashed money corresponding to the valuable data is delivered by hand to the candidate for the receipt who has been authenticated as a payee oneself of the valuable data.

45. The method according to claim 1, wherein inherent identifiers are respectively applied to all valuable data issued by the settlement service provider, and only the identifiers of valuable data circulating in markets are kept by the settlement service provider.

46. The method according to claim 45, wherein, in said proprietary right transferring step, when an identifier applied to the valuable data is kept by the settlement service provider, the proprietary right of said valuable data is transferred to said candidate for the receipt.

47. The method according to claim 1, wherein any data is attached to the electronic information body.

48. The method according to claim 47, wherein at least one of date, time, name of the receiver, address of the receiver, telephone number of the receiver, e-mail address of the receiver, reason for payment of the consideration, amount of money of the consideration, delivery destination of a commodity dealt with in the transaction and electronic information body for transmission of valuable data owned by the receiver is attached as said any data.

49. The method according to claim 1, wherein the supplier opens an electronic information body owned by the supplier to the general public, and
the receiver obtains the electronic information body opened to the general public in the obtaining step.

50. The method according to claim 1, wherein the settlement service provider issues an electronic checkbook having payable amount information to the receiver in advance,
in the requesting step, the receiver transmits the electronic checkbook together with the electronic information body to the settlement service provider when the receiver requests the settlement service provider to attach valuable data having a value corresponding to the consideration necessary for the transaction to said electronic information body, and
in the attaching step, when said valuable data is attached to the electronic information body, the settlement service provider prepares a new electronic checkbook having payable amount information obtained by subtracting the amount corresponding to the value of said valuable data from the payable amount information of said electronic checkbook to return said new electronic checkbook to the receiver.
